(19) United States
(12) Patent Application Publication
(10) Pub. No.: US 2004/0117325 A1
(43) Pub. Date: Jun. 17, 2004

(54) Post office effectiveness model (POEM)

(76) Inventors: Charles R. Cash, New Albany, OH (US); W. Douglas Poynter, Duluth, GA (US); Phinsuda Tarmy, Alpharetta, GA (US)

Correspondence Address: PAUL W. MARTIN, LAW DEPARTMENT, WHQ-4, 1700 S. PATTERSON BLVD., DAYTON, OH, 45479-0001, US

(21) Appl. No.: 10/319,473

(22) Filed: Dec. 16, 2002

(51) Int. Cl. G06F 17/60

(52) U.S. Cl. 705/401; 705/8

(57) ABSTRACT

The Post Office Effectiveness Model (POEM) is a self-contained PC desktop application enabling an analyst to quantitatively predict the operational and financial impact of changes to Post office (PO) and Automated Postal Center (APC) operations. This application, according to the present invention, includes a Simulation Analysis Module and a Financial Analysis Module. The Simulation Module consists of two simulation models: APC model and PO model. An analyst can use the PO model to predict the effect of an unlimited number of changes in post office design, customer demand patterns, and counter procedures on post office performance. The Financial Analysis Module allows the user to create a Profit and Loss (P&L) statement showing the cash flows, Net Present Value (NPV), Internal Rate of Return (IRR) for deploying APCs using simulation results or user input values. An analyst can use the POEM to provide a sound and quantified basis for developing a business case for investing in new technologies, i.e., APC, or other design and procedure changes in a post office environment.

### RELATED APPLICATIONS

The present invention claims priority from a U.S. Provisional Application Serial No. 60/151,269 filed on Aug. 31, 1999 entitled “Management Decision Modeling Software Applications” which is hereby incorporated by reference in its entirety into this specification. The present application is related to U.S. patent application Ser. No. 09/653,195 filed on Aug. 31, 2000 entitled “Branch Effectiveness Model Application” (NCR Docket No. 8320) and Ser. No. 10/197,476 filed on Jul. 18, 2002, entitled “Convenience Store Effectiveness Model” (NCR Docket No. 9567) which are hereby incorporated by reference in their entirety into the present specification. The present application is also related to U.S. patent application Ser. No. 09/653,196 filed on Aug. 31, 2000 entitled “Lane and Front End Effectiveness Model” which is hereby incorporated by reference in its entirety into the present specification.

### FIELD OF THE INVENTION

The present invention relates generally to Management Decision Modeling (MDM), and more particularly, to a type of MDM used for modeling a post office. Even more particularly, the present invention is related to an MDM called a Post Office Effectiveness Model (POEM) used to predict the impact of changes to an existing or future post office.

### BACKGROUND ART

Management Decision Models (MDM) are a class of software applications and methodologies providing decision-makers with new information about their business helping decision-makers address key business issues. MDMs are flexible, data driven, software tools used to predict the operational effect of process, design, or technology changes on productivity and other business performance measures, as well as the financial impact of such changes. MDM may be customized to address questions relating to any business domain, including product manufacturing, service industry, and retail operations (e.g., convenience stores and post offices). MDMs have graphical user interfaces. Components of an MDM include 1) a database management module to maintain the application's input data parameters and output data performance measures; 2) a simulation engine to represent the dynamic interaction between the elements of a system, such as the people, equipment, material, information and energy; 3) animation to visualize how the system reacts to changes in input parameters; 4) an environmental design layout module for calculating physical space requirements to accommodate new equipment or process changes; and 5) a financial module which transforms operational performance measures into financial metrics to assess the return on investment for the evaluated changes.

The output from an MDM indicates the predicted performance of the system using metrics that are the most meaningful to the decision-maker. The output includes operational performance measures, such as queuing times or sizes, equipment utilization, number of stock-outs, and customer system times as well as financial metrics, such as Internal Rate of Return (IRR), Net Present Value (NPV), and Payback Period.

There are no MDMs that are currently available to characterize an existing or future post office to address complex design and operational problems that are quantitatively difficult to solve.

There are no currently available computer software applications for addressing complex post office design and operational problems using the methodology and features provided by the present invention. Thus, a need exists in the art for a POEM which has the flexibility, features, and functionality to address strategic issues relating to post office design and operational problems.

### DISCLOSURE/SUMMARY OF THE INVENTION

It is therefore an object of the present invention to provide a model for predicting the impact of changes to a post office.

Another object of the present invention is to provide a model to predict the impact of changes to an existing or future post office.

Another object of the present invention is to provide a simulation model which shows an animation and outputs results based on changes to an existing or future post office.

Yet another object of the present invention is to provide a simulation model having numerous parameters such that a user with little or no simulation or modeling experience can easily use the POEM application.

The POEM is a self-contained computer software executable enabling an analyst to quantitatively predict the impact (operationally and financially) of changes to Post Office and Automated Postal Center (APC) operations. An APC is a self-service device enabling customers to mail letters or packages, purchase stamps, purchase phone cards, lookup information, and possibly perform other related transactions. Modeling tools, such as the POEM, when used in a customer engagement or product research and development role can help provide a sound and quantified basis for developing a business case for investing in new technologies, i.e., APC, or other design and procedure changes.

An embodiment of the POEM application, includes two simulation models and a financial analysis model. The first simulation model is an APC model and the second model is a Post Office model (PO model). The APC model represents the detailed transaction process performed by customers at an Automated Postal Center and allows the user to predict the effect of changes in APC design, transaction features, and transaction times on customer service (e.g., queue times, queue size, and throughput). Modeling an APC by itself provides a clearer understanding of the relationship between its features and its performance without the additional assumptions and work required to characterize the environment in which it is located.

The preferred embodiment of the PO model represents the multifaceted interactions between customers, staff, and primary service points of a Post Office (e.g., self-service points, drop-off boxes, writing desks, scales, copiers, checkout counters, etc.). Although, one intended use of the PO model is to predict the impact of deploying APC in the post office environment, a user can use the PO model to predict the effect of an unlimited number of changes in post office design, customer demand patterns, and checkout procedures on post office retail performance.

The financial analysis model allows the user to create a Profit and Loss (P&L) statement showing the cash flows, Net Present Value (NPV), IRR for deploying APCs using simulation results or user input values.

An analyst can use the POEM to evaluate, in detail, different post office configurations and transaction processes and the effect these changes have on post office performance. The overall purpose of the POEM is to provide a product design team, consultant, or postal service manager with timely information to reduce the risk and uncertainties of investing in new technologies or design changes by predicting their impact and return before committing resources to their acquisition or implementation.

POEM is a decision support software application assisting postal service management personnel in making strategic business decisions. POEM is inventive because it addresses business problems in a unique way. It is flexible so the user can address an unlimited number of process or design issues relating to customer points of transaction in a post office domain and the detailed customer interactions with a postal kiosk and post office retail service operations. It is data-driven, so the user can customize a model to a particular problem by entering the appropriate parameter values (eliminating any software programming required by the user). It is integrated, so the user can apply one or more components of the tool to address their business questions. It is designed to be usable by individuals that are knowledgeable about an application domain and not necessarily knowledgeable about the tool's methodology. In summary, POEM provides a structured, quantitative approach to better allocate and profitably manage resources and technology changes throughout a network of post office locations.

POEM is a software application providing postal service management with a new tool and methodology for better allocating resources, improving post office performance, and assisting in the successful deployment of postal kiosk technology in a post office environment. POEM is a general purpose, flexible, integrated, data-driven, software tool enabling the prediction of the effect of process, design, or technology changes on productivity and other business performance measures, as well as the financial impact of such changes. POEM can be customized by a user using input data characterizing a postal environment to address questions relating to postal kiosk design features or post office retail service operations and customer service.

Components of POEM include:

a database management module to maintain the application's input data parameters and output data performance measures for one or more scenarios,

a simulation engine and multiple simulation models to represent the dynamic interaction between the elements of a post office system, such as post office personnel, POS counter configurations, retail merchandise, self-service kiosks and vending machines, customers, operating procedures, etc.,

animation to visualize how the system reacts to changes in input parameters,

an environmental design layout module which calculates physical space requirements to accommodate new equipment or process changes,

a financial module which transforms operational performance measures generated either by simulation or direct user input into financial metrics to be displayed or printed in numeric or graphical format.

POEM output indicates the predicted performance of the system using metrics most meaningful to the decision-maker and provides the output information in a tabular or graphical form to a display. The metrics include operational performance measures, such as queuing times or sizes, equipment utilization, number of transactions and customer system times as well as financial metrics, such as IRR, NPV and Payback Period.

These and other objects of the present invention are achieved by collecting (or assembling available) data to characterize a particular post office as prescribed by POEM input data dictionary (i.e., a set of input parameters); entering the data into POEM's database module; selecting one or more of POEM components, i.e., simulation models, design layout module, or financial module to analyze the data and to transform the data into actionable information. A method of quantitatively evaluating alternatives to post office operations using a simulation model. Parameter values are input describing post office operations into the simulation model. The simulation model is run and results are outputted from the simulation model.

The above described objects are fulfilled by a method of quantitatively evaluating alternatives to post office operations using a simulation model, design layout module, or financial module. Parameter values are input describing post office operations, then the user selects at least one of the analysis modules to evaluate the performance of the system based on the set of inputs. The simulation model is run and results are outputted from the simulation model.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious respects, all without departing from the invention. Accordingly, the drawings and description thereof are to be regarded as illustrative in nature, and not as restrictive.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1 is high-level block diagram of a computer system usable with a preferred embodiment of the present invention;

FIG. 2 is a tree diagram of transaction types of an automated postal center;

FIG. 3 is a tree diagram of transaction types of a retail checkout counter;

FIG. 4 is a flow diagram overview of a customer engagement process;

FIG. 5 is a flow diagram overview of a modeling process;

FIG. 6 depicts a post office effectiveness model main menu form used in a preferred embodiment of the present invention;

FIG. 7 depicts an example simulation analysis module form used in a preferred embodiment of the present invention;

FIG. 8 depicts a create parameter file form used in a preferred embodiment of the present invention;

FIG. 9 depicts an input module form after creating a test scenario;

FIG. 10 depicts an edit simulation scenario form for a PO model used in a preferred embodiment of the present invention;

FIG. 11 depicts an edit simulation scenario form for an APC model used in a preferred embodiment of the present invention;

FIG. 12 depicts an arrival rate schedule form used in a preferred embodiment of the present invention;

FIG. 13 depicts a balking probabilities form used in a preferred embodiment of the present invention;

FIG. 14 depicts a customer decision matrix form used in a preferred embodiment of the present invention;

FIG. 15 depicts a personnel schedules edit form used in a preferred embodiment of the present invention;

FIG. 16 depicts a distribution of items purchased form used in a preferred embodiment of the present invention;

FIG. 17 depicts a delete parameter file form used in a preferred embodiment of the present invention;

FIG. 18 depicts a first page of the Data Input Dictionary (DID) for the post office model used in a preferred embodiment of the present invention;

FIG. 19 depicts an animation overview screen used in a preferred embodiment of the present invention;

FIG. 20 depicts a main menu form used in a preferred embodiment of the present invention;

FIG. 21 depicts an example set of output statistics for the PO model used in a preferred embodiment of the present invention;

FIG. 22 depicts a graph of number of customers versus time of day used in a preferred embodiment of the present invention;

FIG. 23 is a model summary description used in a preferred embodiment of the present invention;

FIG. 24 depicts a model during processing of a scenario used in a preferred embodiment of the present invention;

FIG. 25 depicts the model after completing replications used in a preferred embodiment of the present invention;

FIG. 26 depicts an output module form for a PO model used in a preferred embodiment of the present invention;

FIG. 27 depicts an output module form for an APC model used in a preferred embodiment of the present invention;

FIG. 28 depicts an example report for a PO model used in a preferred embodiment of the present invention;

FIG. 29 depicts an example report for an APC model used in a preferred embodiment of the present invention;

FIG. 30 depicts a financial analysis form used in a preferred embodiment of the present invention;

FIG. 31 depicts a financial analysis output form used in a preferred embodiment of the present invention;

FIG. 32 depicts a profit and loss statement used in a preferred embodiment of the present invention;

FIG. 33 (comprised of FIGS. 33A and 33B) depicts a logical architecture for the POEM simulation model used in a preferred embodiment of the present invention;

FIG. 34 depicts an overview of the simulation process;

FIG. 35 is a flow diagram of the financial analysis module used in a preferred embodiment of the present invention;

FIG. 36 (comprised of FIGS. 36A and 36B) is a flow diagram depicting the customer activity module used in a preferred embodiment of the present invention;

FIG. 37 (comprised of FIGS. 37A and 37B) is a flow diagram depicting the balk determination process used in a preferred embodiment of the present invention;

FIG. 38 is a flow diagram depicting the general service process used in a preferred embodiment of the present invention;

FIG. 39 is a flow diagram depicting a automated postal center process used in a preferred embodiment of the present invention;

FIG. 40 is a flow diagram depicting a counter process used in a preferred embodiment of the present invention;

FIG. 41 (comprised of FIGS. 41A and 41B) is a flow diagram depicting a clerk schedule process used in a preferred embodiment of the present invention; and

FIG. 42 (comprised of FIGS. 42A and 42B) is a flow diagram depicting a customer transaction process at an automated postal center used in a preferred embodiment of the present invention.

### BEST MODE FOR CARRYING OUT THE INVENTION

A method and apparatus for evaluating an existing or future post office are described. In the following description, for purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

Hardware Overview

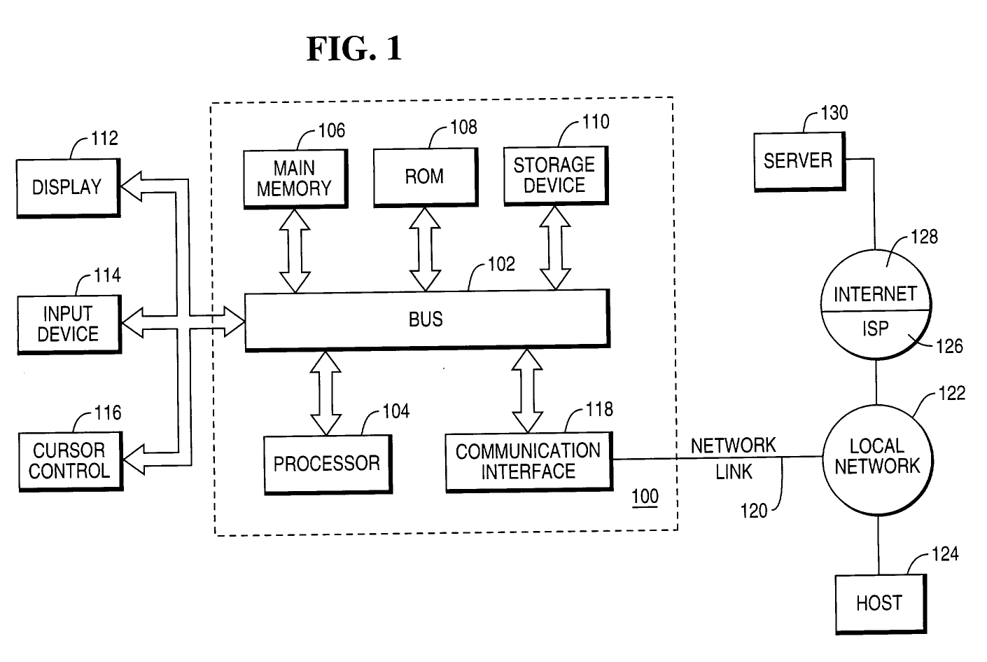

FIG. 1 is a block diagram illustrating an exemplary computer system 100 upon which an embodiment of the invention may be implemented. The present invention is usable with currently available personal computers, mini-mainframes and the like.

Computer system 100 includes a bus 102 or other communication mechanism for communicating information, and a processor 104 coupled with the bus 102 for processing information. Computer system 100 also includes a main memory 106, such as a random access memory (RAM) or other dynamic storage device, coupled to the bus 102 for storing information and instructions to be executed by processor 104. Main memory 106 also may be used for storing temporary variables or other intermediate information during execution of instructions to be executed by processor 104. Computer system 100 further includes a read only memory (ROM) 108 or other static storage device coupled to the bus 102 for storing static information and instructions for the processor 104. A storage device 110, such as a magnetic disk or optical disk, is provided and coupled to the bus 102 for storing information and instructions.

Computer system 100 may be coupled via the bus 102 to a display 112, such as a cathode ray tube (CRT) or a flat panel display, for displaying information to a computer user. An input device 114, including alphanumeric and other keys, is coupled to the bus 102 for communicating information and command selections to the processor 104. Another type of user input device is cursor control 116, such as a mouse, a trackball, or cursor direction keys for communicating direction information and command selections to processor 104 and for controlling cursor movement on the display 112. This input device typically has two degrees of freedom in two axes, a first axis (e.g., x) and a second axis (e.g., y) allowing the device to specify positions in a plane.

The invention is related to the use of a computer system 100, such as the illustrated system, to display a post office effectiveness model. According to one embodiment of the invention, the post office effectiveness model and display is provided by computer system 100 in response to processor 104 executing sequences of instructions contained in main memory 106. Such instructions may be read into main memory 106 from another computer-readable medium, such as storage device 110. However, the computer-readable medium is not limited to devices such as storage device 110. For example, the computer-readable medium may include a floppy disk, a flexible disk, hard disk, magnetic tape, or any other magnetic medium, a CD-ROM, any other optical medium, punch cards, paper tape, any other physical medium with patterns of holes, a RAM, a PROM, an EPROM, a FLASH-EPROM, any other memory chip or cartridge, a carrier wave embodied in an electrical, electromagnetic, infrared, or optical signal, or any other medium from which a computer can read. Execution of the sequences of instructions contained in the main memory 106 causes the processor 104 to perform the process steps described below. In alternative embodiments, hard-wired circuitry may be used in place of or in combination with computer software instructions to implement the invention. Thus, embodiments of the invention are not limited to any specific combination of hardware circuitry and software.

Computer system 100 also includes a communication interface 118 coupled to the bus 102. Communication interface 108 provides a two-way data communication as is known. For example, communication interface 118 may be an integrated services digital network (ISDN) card or a modem to provide a data communication connection to a corresponding type of telephone line, e.g., an analog line or a digital subscriber line (DSL). As another example, communication interface 118 may be a local area network (LAN) card to provide a data communication connection to a compatible LAN. In the preferred embodiment communication interface 118 is coupled to a virtual blackboard. Wireless links may also be implemented. In any such implementation, communication interface 118 sends and receives electrical, electromagnetic or optical signals which carry digital data streams representing various types of information. Of particular note, the communications through interface 118 may permit transmission or receipt of the post office effectiveness model. For example, two or more computer systems 100 may be networked together in a conventional manner with each using the communication interface 118.

Network link 120 typically provides data communication through one or more networks to other data devices. For example, network link 120 may provide a connection through local network 122 to a host computer 124 or to data equipment operated by an Internet Service Provider (ISP) 126. ISP 126 in turn provides data communication services through the world wide packet data communication services through the world wide packet data communication network now commonly referred to as the “Internet” 128. Local network 122 and Internet 128 both use electrical, electromagnetic or optical signals which carry digital data streams. The signals through the various networks and the signals on network link 120 and through communication interface 118, which carry the digital data to and from computer system 100, are exemplary forms of carrier waves transporting the information.

Computer system 100 can send messages and receive data, including program code, through the network(s), network link 120 and communication interface 118. In the Internet example, a server 130 might transmit a requested code for an application program through Internet 128, ISP 126, local network 122 and communication interface 118. In accordance with the invention, one such downloaded application provides for a post office effectiveness model as described herein.

The received code may be executed by processor 104 as it is received, and/or stored in storage device 110, or other non-volatile storage for later execution. In this manner, computer system 100 may obtain application code in the form of a carrier wave.

The POEM application provides an approach to quickly assess the impact of changes to APC design features or a mix of service points and operations of a Post Office without incurring unnecessary costs. The preferred embodiment of this software tool has a Graphical User Interface (GUI) enabling the user to:

Input and manage data characterizing a particular simulation or financial scenario;

Select and run one or more scenarios corresponding to one of the two simulation models or calculate the financial return of one or more APCs, and;

View or write (to a file, printer, or other software application) the simulation or financial results.

The preferred embodiment of POEM includes two simulation models and a financial analysis model. The first model is called the APC model and enables the user to predict the effect of changes in APC design, transaction features, and transaction times on customer service (e.g., queue times, queue size, and throughput).

The second model, called the PO model, represents the complex interactions between customers, staff, and the primary service points of a Post Office (e.g., self-service points, drop-off boxes, writing desks, scales, copiers, checkout counters, etc.). Although, the intended use of the PO model is to predict the impact of deploying APC in a post office environment, a user can use the PO model to predict the effect of an unlimited number of changes in post office design, customer demand patterns, and checkout procedures on post office performance. The user can create scenarios that characterize a post office's operations. For example, the user can specify the number and type of service points, transaction times, customer arrival patterns and numbers of transactions per customer, and personnel schedules.

The financial analysis model allows the user to create a P&L statement that displays the annual cash flows and return on investment for one or more APCs using transactions counts from simulation results or transaction counts and financial values entered by the user.

The POEM application provides an analyst with a process and a tool usable to predict the impact of changes to APC design or post office environments without physically making the changes. An analyst may use the POEM application along with data representative of a retailer's operations to carry out a detailed analysis to determine which alternate (or set of alternatives) configurations and store procedures performs the best. Insight from the customer's data and results from running the model assist the analyst in identifying and recommending alternative business methods affecting:

Productivity;

Customer service;

Operating costs, and;

Overall profitability.

These improvements may result from the implementation of new checkout technologies or procedures, determining the appropriate number and type of APC or other service points inside and outside of a store, refinements in personnel scheduling, etc.

Two components of a preferred embodiment of the POEM application are now described: the Simulation Analysis and Financial Analysis Modules.

The Simulation Analysis Module allows the user to create and manage input data scenarios characterizing event times, logic, and configuration for both of the APC and PO simulation models. For example, the user may create a scenario that specifies number of counter positions, number of vending machines, transaction times, customer arrival patterns and many other requirements. The Data Input Dictionary (DID) for each simulation model lists and defines the parameters used in each model. Appendix A contains the combined DID and the default scenario parameter values for each model.

Although there are included methods to maintain data input integrity, such as limiting the range of values for input parameters, the development of procedures that would prevent the user from running unreasonable model scenarios is known to persons skilled in that art. Thus, the user is expected to understand the definitions of the input parameters and to use good judgment when running the model. Users may make invalid inferences based on results from the POEM application.

Running Simulation

The Simulation Analysis Module allows the user to select one of the models and one or more input scenario, and run the simulation. Each simulation model can run with or without animation. A model with animation turned on is more effective for understanding and communicating the model's results. In many cases the animation provides a visual check that the model is running the way the user expects. There are also several screen views providing additional insight when the model is run with animation. With animation turned off, the models execute much faster, allowing the user to conduct more statistically sound experiments and evaluate more scenarios in a shorter time period. This mode of running scenarios is referred to as the analysis mode.

Simulation Output

The Simulation Analysis Output Module allows the user to view and write the results of the simulation to a file, printer, or another software application. The model output includes performance measures like APC and clerk utilization, labor times, queue times, queue lengths, balk counts, and transaction volumes.

Financial Analysis Module

The Financial Analysis Module allows the user to predict the impact APCs will have on annual cash flows. The Financial Analysis Module has a similar interface and functionality as the Simulation Analysis Module. That is, the user can create, save, edit, delete, print, and run input parameter files to predict the impact of changes in financial (or simulation) input values on financial results.

Financial Output

The Financial Analysis Output Module allows the user to view and write the results of the financial analysis to a file, printer, or another software application. The financial output report is in the form of a P&L statement and shows the effect of one or more APCs on a postal service's cash flow. The report also provides three financial metrics: NPV, IRR, and approximate payback period.

Design of the POEM

The POEM application contains two flexible, data driven simulation models that represent the transaction process at an APC and the operations at a post office. By data driven, it is meant that the user specifies input parameter values that control the model's event times, logic, and resource configuration. This design feature allows the user to analyze an unlimited number of “What-if” scenarios without having to modify (or reprogram) any of the application's analysis modules. Each model has a DID that lists and defines all the parameters used in the model. 1

The preferred embodiment of the POEM contains a flexible, data driven financial model that quickly generates a P&L statement showing the financial return of one or more APCs over a user-specified planning period.

The overall goal of these models is to provide a postal service manager (or APC product manager) with decision-making information about APC designs and transaction procedures, so they can better manage and grow their business.

APC Model Logic

The APC model allows the user to analyze, in detail, changes in APC designs, transaction procedures, and transaction times. For instance, one business question might be “what is the impact on average queuing time if we could reduce the parcel post mailing time below two minutes?”

The following five steps illustrate the basic steps represented in the transaction process of the APC model:

1. A customer “arrives” at an APC.

2. The customer may have to wait before they can receive service. The customer may also balk if the queue size is beyond a preset threshold.

3. Once APC resources are available the transaction process begins. The type and duration of the transaction is based on user input.

4. The transaction may or may not be successful.

5. After the transaction is finished or unsuccessful, the customer departs the APC.

The APC model allows the user to represent customer demand in one of two ways: Unlimited or Limited Arrival mode. In the Unlimited Arrival mode, there is always a customer available to receive service when an APC has capacity (an ideal situation). In this mode, the user can evaluate the maximum throughput (defined as either the number of transactions or items per time unit) of an APC. In the Limited Arrival mode, there is a time interval between customer arrivals. The user can enter the mean inter-arrival time (i.e., the inverse of the arrival rate) and whether the inter-arrival distribution is constant or random. The Limited Arrival mode is used to evaluate customer queuing behavior. In general, the Limited Arrival mode is, perhaps, more representative of the actual customer arrival process.

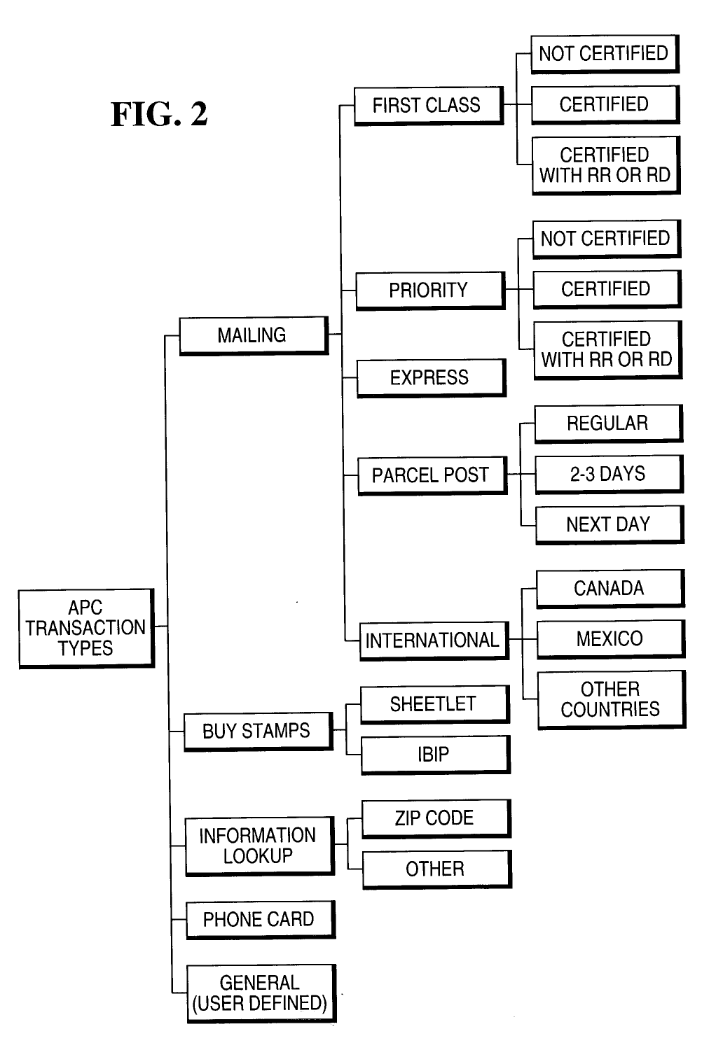

FIG. 2 shows the taxonomy of the types of transactions in customer can perform at an APC. There are 19 transaction types ranging from a first-class non-certified mail piece to general user defined transaction. The frequency of each transaction type and its duration are user specified.

Representing the transaction process at an APC is an important part of the APC model. The following outline of events is one preferred representation of the transaction process at an APC:

Information Entry

Customer enters information required for a particular service

Possible unsuccessful transaction

If the transaction is unsuccessful, the customer leaves at this step

Miscellaneous

Possible extra activities that are not part of the transaction but add to the transaction time. These activities might not occur in each transaction.

Finalization

Customer pays for service

Tender times depend on tender type, i.e. cash, credit, debit, or other

Information lookup transaction does not have a Finalization event

Printing/Dispensing

Customer waits for stamps and/or forms to print and dispense before retrieving

Possible unsuccessful approval processing task

Receipt Printing and Retrieval

Customer waits for receipt to print and dispense before retrieving

The user can specify the duration of these events.

Assumptions for the APC Models

The following list illustrates several assumptions that may be embodied in the logic of the APC model:

1. Transactions cannot start for the next customer until the transaction of the previous customer is finished.

2. A customer may perform multiple transactions at an APC.

3. A customer leaves if a transaction is unsuccessful.

Design of the PO Model

The PO model represents the interactions between customers, staff, and Post Office resources in a typical post office environment. Like the APC model, the PO model is flexible and data driven. The primary difference is this model represents the overall post office retail operations and not just the APC process. As a result of this larger scope, the PO model does not go into the level of detail in the transaction process that the APC model provides.

PO Model Resources

Two key resource types represented in the PO model are service points and staff.

Service points

Service points represented in this model include APCs, copiers, multiple stamp vending machines, single stamp vending machines, scales, parcel and letter drop-off boxes, writing desks, general service point (user defined), and retail counters. The user enters the number and type of service points available for a scenario. Retail counter positions require a clerk to process the transaction, and a supervisor to process customer interventions when intervention events are possible. The user can specify the retail lobby hours when retail counters are open to customers. Other service points are available throughout the scenario.

Staff

The PO model represents two types of personnel: clerks and supervisors. The user can specify personnel schedules (i.e., the number of staff available) in 30 minute intervals. Supervisors are scheduled in a pool and their only responsibility in the model is to respond to customer interventions during counter transactions.

PO Model Customer Logic

The following 3-steps describe the basic customer flow represented in the PO model:

1. A customer arrives at the post office. The user enters the expected number of arrivals per hour in 15-minute intervals.

2. A customer may visit any service point, wait in line, or balk (leave without receiving service when the line is longer than the present threshold). The user may set up the model such that the customer that balks from retail counters goes to use an ABC instead, and vice versa.

3. After a customer finishes their transactions at one or more service points, they leave the post office and depart.

PO Model Resource Transaction Logic

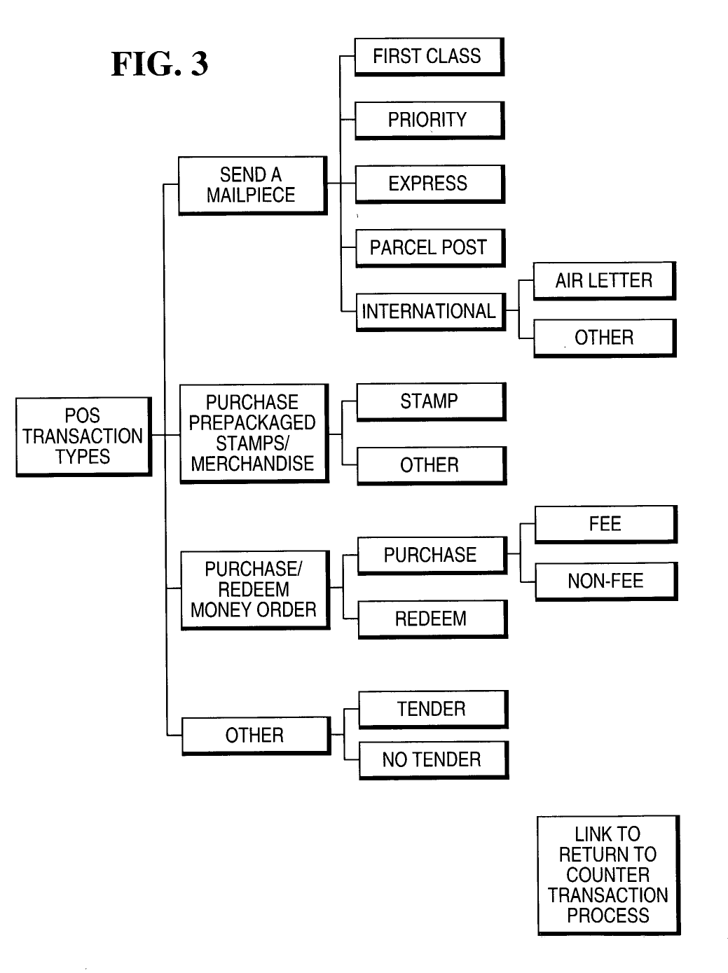

The PO model represents transaction times as a single event for all but two key service points defined in a scenario. These service points are the APC and retail counters. The transaction types and process at an APC is similar to the process described in the APC model. Transaction types at the retail counters are shown in FIG. 3.

A customer may add special services, such as registered, insured, delivery confirmation, etc. to mailing transactions. The PO model allows up to six classes of special services. The user can specify the probability that a customer adds a special service to each mailing transaction type, as well as the probability that a special service is one of the six types.

The PO model represents the transaction process at the counter using the following events for all transaction types:

Initialization

The initialization event represents the time a customer unloads items or mailpieces and converses with the clerk before the start of an item processing event.

Item Processing

This event represents the time for the clerk to process items at the POS system.

Special Service Processing

Special service is only possible for mailing transaction. A transaction may have multiple special services added to it.

Error and Miscellaneous

A customer may experience additional delays for error or miscellaneous events based on user input values. Error event requires supervisor's assistance.

Finalization

The finalization event represents the Sender time by tender type.

Customers may perform more than one transaction during their visit to the counter. The number and type of transactions performed are specified by input parameters.

The following is a list of definitions for terms used in this guide.

Balking A term used to describe behavior of a customer who decides not to enter a queue upon arriving and leaves without receiving service.

CDM Customer Decision Matrix—governs the sequences of resources a customer visits once they enter the post office.

APC Automated Postal Center (Self-service device enabling customers to perform transactions, e.g., sending mail, buying stamps, etc.)

APC Model Automated Postal Center Simulation Model

PO Post Office (model)

PO Model Post Office Simulation Model

IRR Internal Rate of Return—annual percentage rate of return for an investment (i.e., the interest rate that causes the discounted present value of benefits in a cash flow to be equal to the discounted present value of the costs)

NPV Net Present Value (the net present value or worth of future money receipts and disbursements)

P&L Profit and Loss Statement (Standard form of a financial report)

Queuing All the simulation models consider a customer to be queuing (time or size-number waiting in line) at a service point, e.g., APC as soon as they arrive at the service point until they start their transaction.

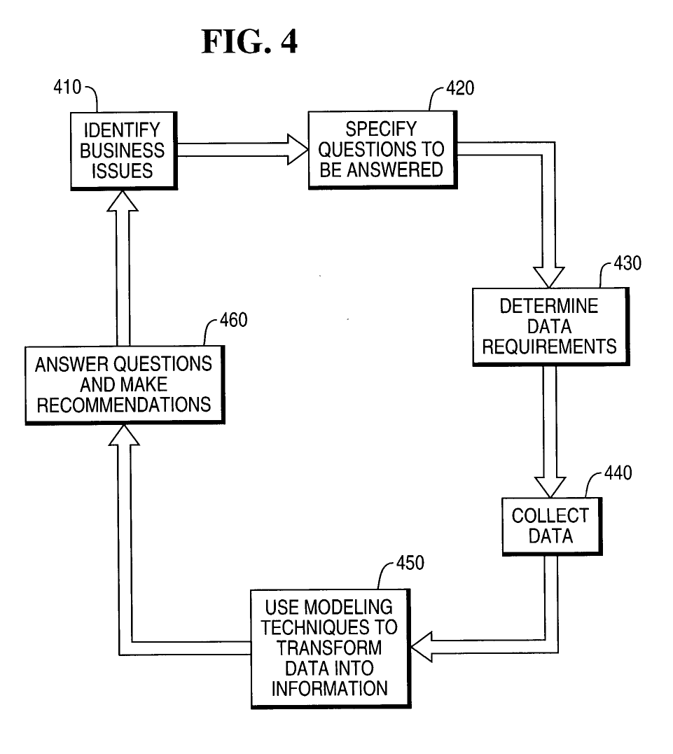

FIG. 4 is an overview of a customer engagement process using POEM. At step 410 business issues are identified. At step 420 the questions are specified that have to be answered. At step 430 data requirements are determined. At step 440 data is collected. At step 450 modeling techniques are used to transform data into information. At step 460 the User answers questions and makes recommendations based upon the output of the modeling techniques. At step 410 the process can be continued in a circular fashion until the modeling technique is completed. The FIG. 4 diagram is an overview of the MDM process.

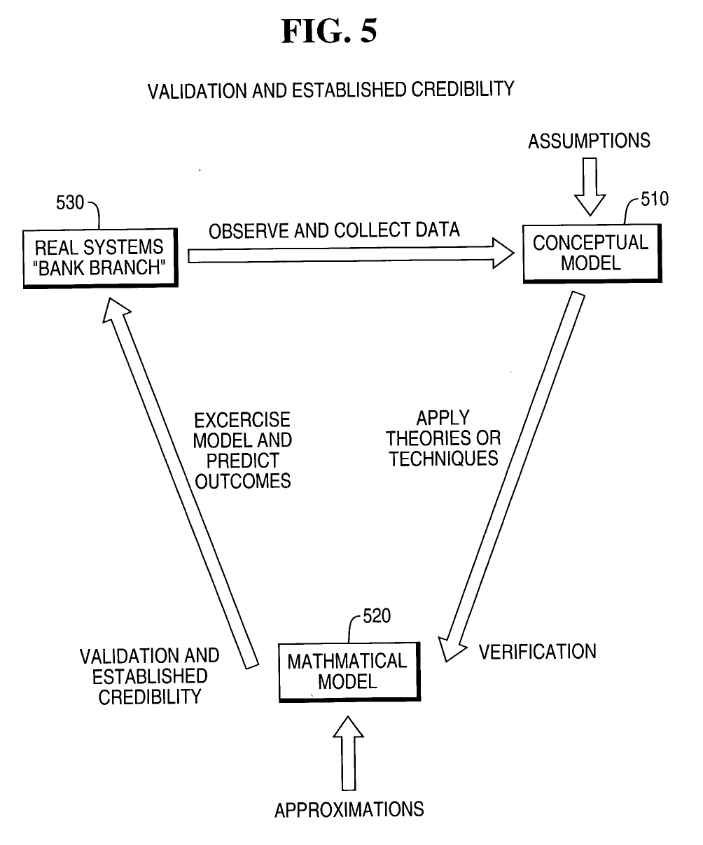

FIG. 5 is an overview of the modeling process (e.g., post office design) used in FIG. 4 and more specifically the modeling technique of step 450 in FIG. 4. The modeling process must be validated and creditability established for the modeling process to be effective. First assumptions must be made and incorporated into the conceptual model 510. The output from the conceptual model is input into a mathematical model 520 which includes approximations. The mathematical model is exercised and outcomes are predicted by checking the mathematical model against the real post office. Data is collected and the post office is observed to validate and establish credibility for the mathematical model.

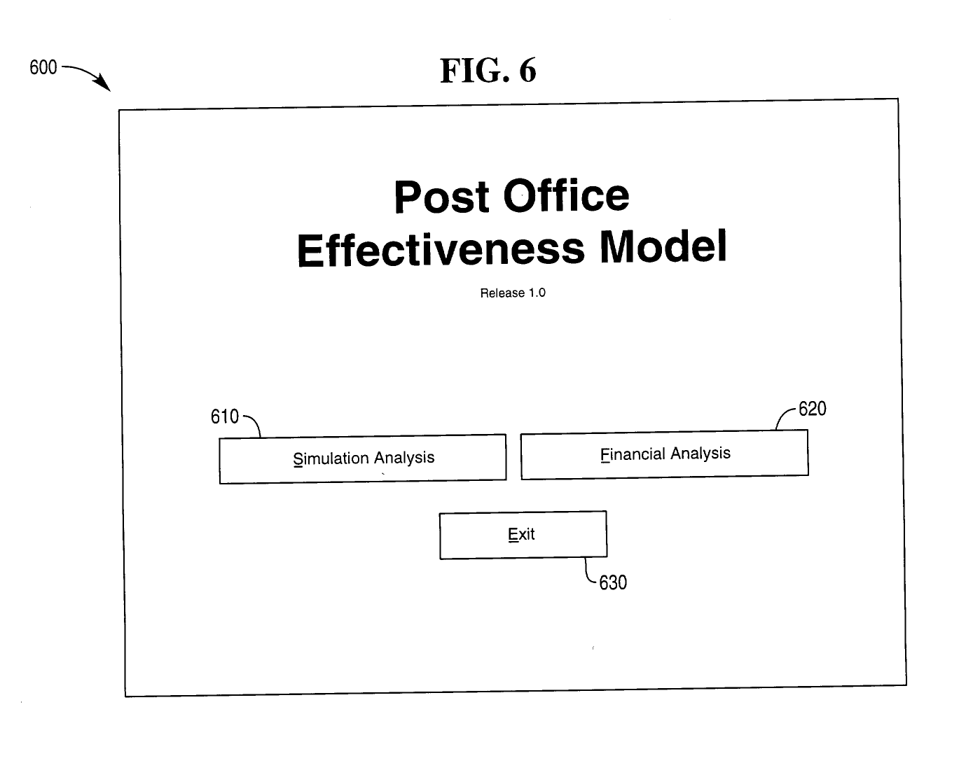

FIG. 6 is a view of an example screen of a Main Menu form 600 of the POEM application. From the Main Menu form 600, the user can enter the Simulation Analysis Module or Financial Analysis Module by selecting the corresponding button, i.e., Simulation Analysis button 610 or Financial Analysis button 620, with their mouse or other pointing device or keyboard.

When finished, the user can close the POEM application by selecting the Exit button 630.

Simulation Analysis Module

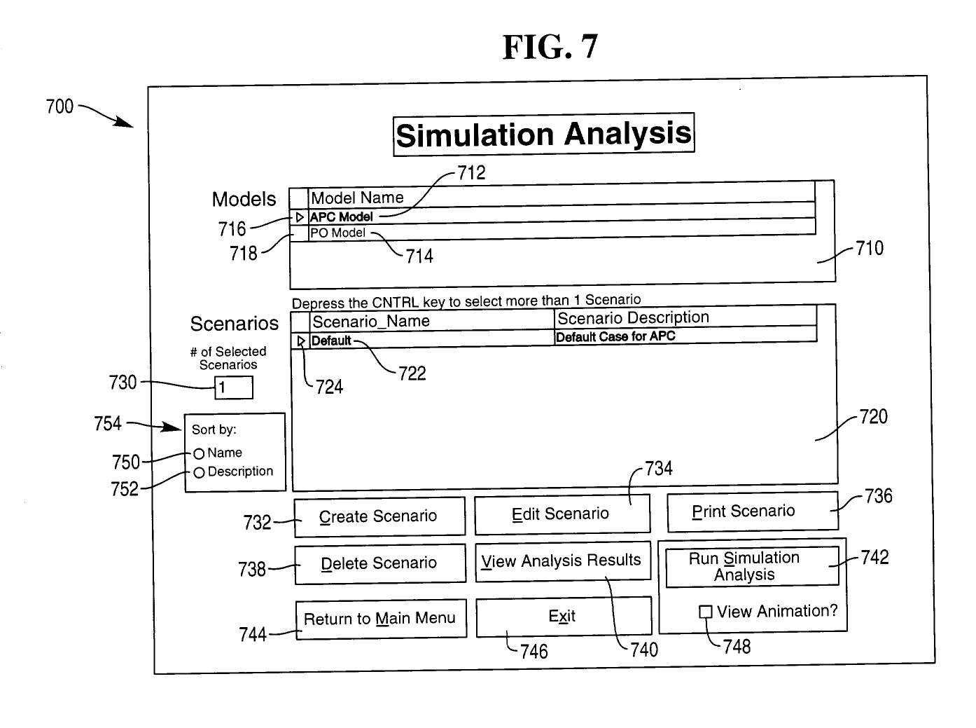

FIG. 7 is a view of an example Simulation Analysis Module form 700. The Simulation Analysis Module allows the user to create, save, edit, delete, and print input parameter files that specify model scenarios. The user can also run a simulation scenario with and without animation from Simulation Analysis Module form 700, and view the analysis results. The user can perform these operations by first selecting the type of model they wish to run in a Models table 710. The Models table 710 includes the previously described name fields: APC Model 712 and PO Model 714. After choosing the simulation model, a Scenarios table 720 will display the scenario files available for that model. As depicted in FIG. 7, the Scenarios table 720 includes a default scenario name field 722. Each simulation model has its own set of input parameter files. The user may then select the input parameter file the user wants to work with (i.e., edit, delete, print or run). To select a model or scenario, the user clicks in the models 712, 714 or scenario name field 722 or on the small rectangle area to the left of these fields 716, 718, and 724, respectively.

The user can select and run multiple scenarios in a batch, one after the other by selecting multiple scenarios in Scenarios table 720 by appropriately clicking the small rectangle area 724 to the left of the Scenario name field 722. A Selected Scenarios counter 730 to the left of the list increments (and decrements, upon deselection of a scenario) by one for each scenario selected. Selecting multiple scenarios is only used for invoking the Run Simulation Analysis button in analysis mode (i.e., animation off).

FIG. 7 shows the selection of the PO Model 714 and the Default scenario 722. The user does not have to select a scenario before selecting a Create Scenario button 732. The user will have the opportunity to select a scenario from which to create a new scenario on a Create Parameter File form 800, described in detail below. The user can select an Edit Scenario button 734 to edit a scenario, a Print Scenario button 736 to print a scenario, a Delete Scenario button 738 to delete a scenario, a View Analysis Results button 740 to view the results of a simulation run, a Run Simulation Analysis button 742 to run a simulation, a Return to Main Menu button 744, and an Exit button 746. If the user wants to run a simulation model with animation, an Animation checkbox 748 is activated before selecting the Run Simulation Analysis button 742. To run a model without animation, the Animation checkbox 748 is left unchecked.

The last two options, i.e., Return to Main Menu button 744, and an Exit button 746, from the Simulation Analysis form 700 allow the user to return to Main Menu form 600 or quit the application.

The Simulation (or Financial) Analysis Modules are designed to allow the user to create numerous scenario (assuming the user has adequate hard disk space available) files for each simulation. The user can sort the list of scenarios by name or description by selecting the corresponding radio button, i.e., Name Sort button 750 and Description Sort button 752, in a Sort By section 754.

When installed on computer system 100, the POEM includes one Default scenario for each simulation model. The values in the Default scenarios are from industry composite data collected and summarized.

Appendix A lists the Model Default Parameter Values in the default scenarios.

Create Parameter File

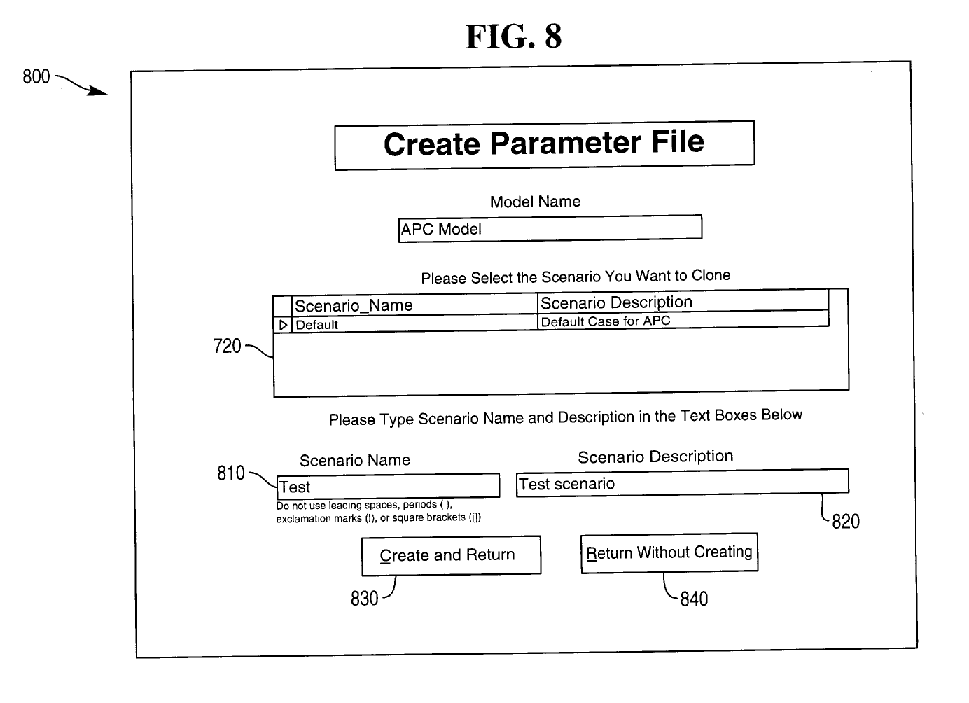

The user can create a new scenario file by activating the Create Scenario button 732 from the Simulation Analysis (or Financial Analysis) Module form 700. FIG. 8 depicts the Create Parameter File form 800. To create a scenario, the user selects the existing file that the user wants to use to create the new file from in the list of scenarios in the center of the Create Parameter File form 800. A scroll bar (not shown) will display to the right of the list when there are more than four scenarios for a model. A name for a new scenario is entered by positioning the cursor in a Scenario Name field 810 and using keyboard to type in the name. The POEM does not allow duplicate scenario names for a simulation or financial model. The Scenario Name can be up to 50 characters (including embedded blank spaces). The user can also enter an optional Scenario Description in the Scenario Description field 820 of up to 55 characters to further describe the parameter file.

After entering the Scenario name in the Scenario Name field 810 and optional description in the Scenario Description field 820, the user should select a Create and Return button 830 (or press Alt-C) to create the scenario file. The application will prompt the user to confirm their selection before returning to the Simulation or Financial Analysis Module form 700. FIG. 8 illustrates the scenario file called “Test” will be created by this process. The other option a user could take from this form is a Return Without Creating button 840 that returns the user to the Simulation Analysis Module form 700 without creating a file. The Scenario table 720 is displayed listing scenario names and scenario descriptions available to be copied.

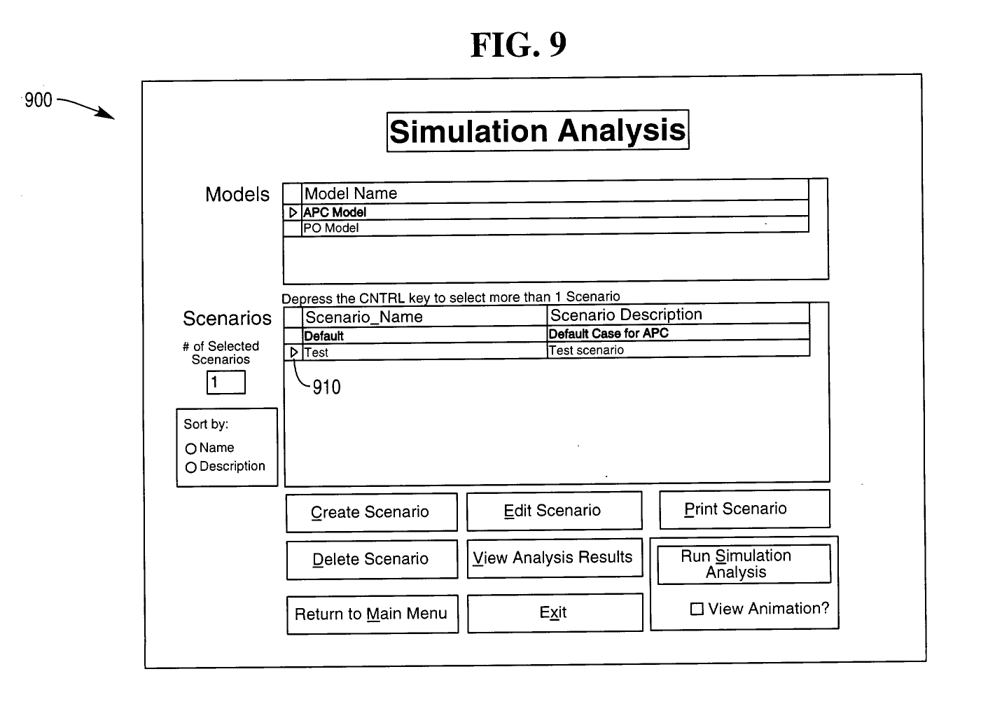

FIG. 9 shows the Simulation Analysis Module form after the creation of scenario “Test” 910. A scroll bar (not shown) will display to the right of the Scenarios list when there are more than eight scenarios for a model.

Data Input Dictionary (DID)

Each of the simulation and financial models in the POEM application has its own set of data parameters the user can control to create a scenario. A model's DID defines the model's input parameters and properties, i.e., parameter values, ranges, and what each parameter controls in a model scenario. The user can view or print a model's DID using the Print Scenario button 736 from the Simulation or Financial Analysis Module form 700. The DID provides the following information for each parameter.

Parameter. The parameter column provides a brief description of how the model uses the input parameter data. If the parameter field contains the word “ARRAY” it means that it has more than one value assigned to it. For example, the user can enter up to 96 values for the parameter representing the expected number of arrivals per hour in 15-minute time intervals for a 24-hour day.

Value. The value column displays the current data value assigned to each parameter. A parameter that has more than one value will not display its values in this field, i.e., the field is blank. Parameters of this type (non-scalar parameters) are edited using an additional edit form.

Range. The range column defines the range of values and the units for the parameter.

Description. The description column provides a more detailed description of the parameter and its use in the model.

Table 1 below shows the number of parameters and values under the control of the user for each of the POEM models.

TABLE 1

| Model | Number of Parameters | Number of Values |
|---|---|---|
| Post Office Model | 281 | 619 |
| APC Model | 278 | 278 |

The simulation parameters for the PO model are divided into seven categories to make them easier to learn and easier to change their values. The seven categories are as follows:

1. Model Parameters;

2. Customer Demand & Routing (CDR in PO Model);

3. Counter Transaction;

4. Labor Schedule;

5. Configuration;

6. APC Transaction, and;

7. Other Resource Transaction.

The parameter categories for the APC model parameters in the Simulation Analysis Module are

1. Model Parameters;

2. Customer Demand;

3. Transaction Probabilities;

4. Mailing Transactions;

5. Buy Stamps Transactions;

6. Information Lookup Transactions;

7. Phone Card Transactions;

8. General Transactions;

9. Tender, and;

10. Financial Parameters.

The main difference between the two categorizations is there is no labor and other resource configuration parameters needed to model a single APC in the APC model. With a more focused scope, the APC model also breaks down the APC transactions into more detailed tasks. These task parameters are grouped into categories by transaction type. Similar APC transaction parameters are contained in the APC Transaction category of the PO model.

In the Financial Analysis Module for the APC model, there is only one category of parameters, i.e., financial. Thus, the user may edit the 95 financial parameters directly from the Edit Financial Analysis form described in detail below. An APC model scenario created in the Simulation Analysis Module will also appear in the Financial Analysis Module (and vice-versa). This feature allows the user to base their financial analysis on simulation results or user input transaction volumes.

Model Parameters

There are three parameters in this category for the PO model. They are “Number of replications”, “Stream number identifier”, and “Check input option identifier”. In the APC model, a fourth parameter, “Time length of scenario”, is included in this category as well. In most applications, the user will not need to change the values of these parameters. If the user wishes more precision in the model's estimates of the mean performance measures, they should increase the value of “Number of replications”. It is recommended that the user does not reduce the value of this parameter below 30 when using the model results to make inferences about the APC or post office design. Changing the value of the “Stream number identifier” will run the scenario using a different sequence of random numbers. Finally, the “Check input option identifier” specifies whether a model writes the scenario parameter values to a file, e.g., c:åPOEMåPOEMChk.out. The purpose of this file is to verify input parameter values or for technical support.

Customer Demand Category

The CDRåcategory has parameters controlling the workload of the post office, such as number of customer arrivals, where customers go, number of counter transactions per customer, etc. The PO model uses a random sampling process (called a non-homogeneous Poisson arrival process) to generate the arrival times. The user controls how many customers arrive by a non-scalar parameter with values that can vary by time of day. Once a customer arrives to the post office, there are other parameters in this category, e.g., the Customer Decision Matrix, that govern what service points customers visit while at the post office. There are also other parameters indicating what customers purchase, such as the distributions of number of counter transactions, in this category. Finally, travel times between service points and balk parameters are included in this category.

Parameters in the Customer Demand category for the APC model allow the user to represent workload in two ways: Unlimited Arrivals and Limited Arrival method (see APC Model Logic section). The user selects between these methods by setting the “Unlimited arrivals option identifier” parameter to 1 (Unlimited Arrivals) or to 0 (Limited Arrivals). Setting this parameter to 1 causes the models to ignore the parameter values in “Constant inter-arrival option identifier” and “Customer arrival rate”. Otherwise, the user needs to enter values in these two parameters for the models to generate customer arrival times.

Transaction Characteristics Category

The Transaction Characteristics category contains parameters describing transaction types and their duration at different service points in the PO model. In the PO model, the transaction characteristic parameters are grouped into three categories: APC, counter, and other resources. In the APC model, Transaction Characteristics are further divided into the 5 different APC transaction types, e.g. mailing transactions, buy stamps transactions, and so forth.

Tender Category

The Tender category (APC model only) contains parameters describing tender time by tender type. The time it takes to tender is not influenced by the type of transaction performed.

Labor Schedule Category

Parameters in the Schedules category for the PO model allow the user to enter clerk and supervisor schedules in 30-minute intervals during a scenario. The clerk's only responsibility in the PO model is to process counter transactions. A customer cannot receive service at the retail counter if there is not at least one clerk scheduled. The supervisor's only role in the PO model is to respond to counter transaction intervention requests. A customer cannot finish a transaction that requires intervention if there is no supervisor available. The APC model obviously does not contain a labor resource.

Configuration Category

The Configuration category contains parameters defining the length and resources in a scenario, e.g., the number of counter positions, the number of APCs, etc. Although, the DID provides definitions for all the parameters in a model, there are requirements for several of the Configuration parameters that are important to understand. The PO model requires at least one clerk to be at the counter during retail lobby hours. This means the user must specify a value of at least one for each time interval on the “Schedule of clerks” parameter between the “Retail lobby start time” and “Retail lobby end time” parameters. The user must define at least one unit of a resource (e.g., vending machine, scale, etc.) for it to exist in a PO model scenario. If the user sends a customer to a resource (via the CDM logic) that does not exist, then the model will terminate the scenario and write an error message to a specific file, e.g., c:åPOEMåPOEMChk.out. Also the model will write an error message to the screen file if the user is running the scenario in animation mode.

Financial Parameters Category

The financial category (APC Model only) includes parameters the user can enter to evaluate the financial impact of one or more APCs. These parameters allow the user to specify the following values:

Revenue by transaction type and for other variable and fixed revenue amounts;

Annual % growth in volume by transaction type;

Costs by transaction type and other variable and fixed cost amounts;

Number of APCs, purchase price, set-up cost and annual maintenance cost, and;

Cost of capital, inflation rate, depreciation life, etc.

The user can also specify whether to use transaction volumes from simulation analysis or input values directly into the financial parameters. The parameters in the financial category are only accessible from the Edit Financial Scenarios form in the Financial Analysis Module.

Edit Simulation Scenario

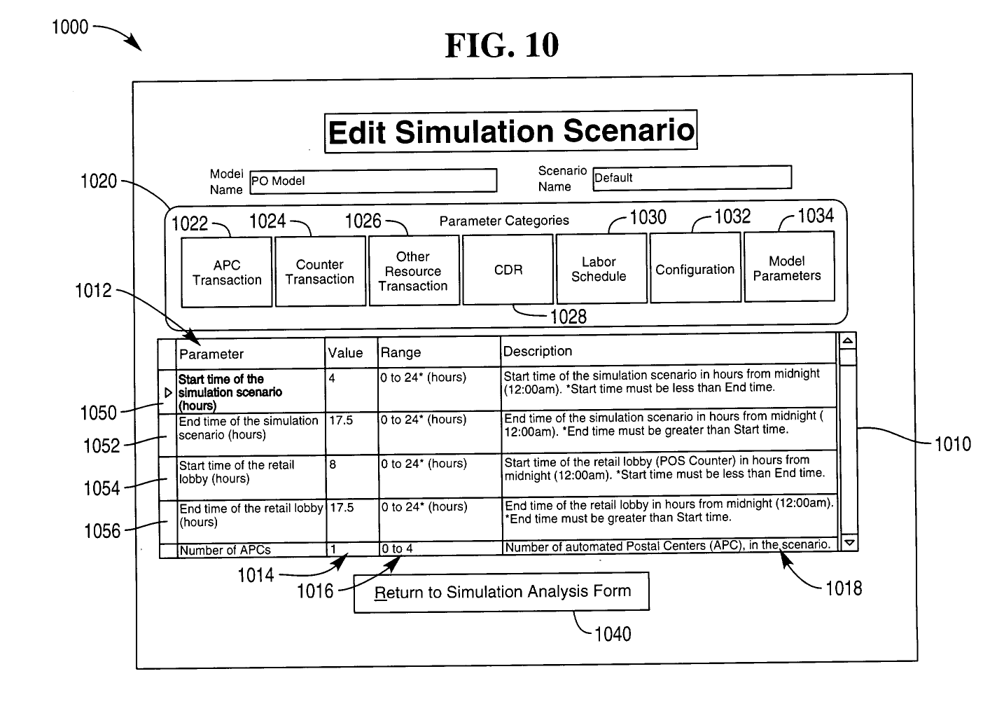

To modify the parameter values for a scenario, the user should select the Edit Scenario button 734 on the Simulation (or Financial) Analysis Module form 700. FIG. 10 depicts the Edit Simulation Scenario form 1000 for the PO model in the Simulation Analysis Module. The Edit Simulation Scenario form 1000 allows the user to view or change the values for each parameter in the scenario files created by the user. Recall that the user cannot change the values in a model's Default scenario.

Each time the user enters this form, an edit table 1010 displays the full set of parameters in the DID. The edit table 1010 includes a Parameter column 1012, a Value column 1014, a Range column 1016, and a Description column 1018. The user can use the scroll bar to the right of the edit table 1010 to browse through the full set. Alternatively, the user can view a subset of the parameters corresponding to a particular category by clicking on the category button in the Parameter Categories section 1020. The Parameter Categories section 1020 includes an APC Transaction button 1022, a Counter Transaction button 1024, an Other Resource Transaction button 1026, a CDR button 1028, a Labor Schedule button 1030, a Configuration Button 1032, and a Model Parameters button 1034. For example, to view a subset of parameters corresponding to the transactions performed at the point of sale counter, click on the Counter Transaction button 1024. The Edit Simulation Scenario form 1000 also includes a Return to Simulation Analysis Form button 1040 to return the user to the Simulation Analysis form 700.

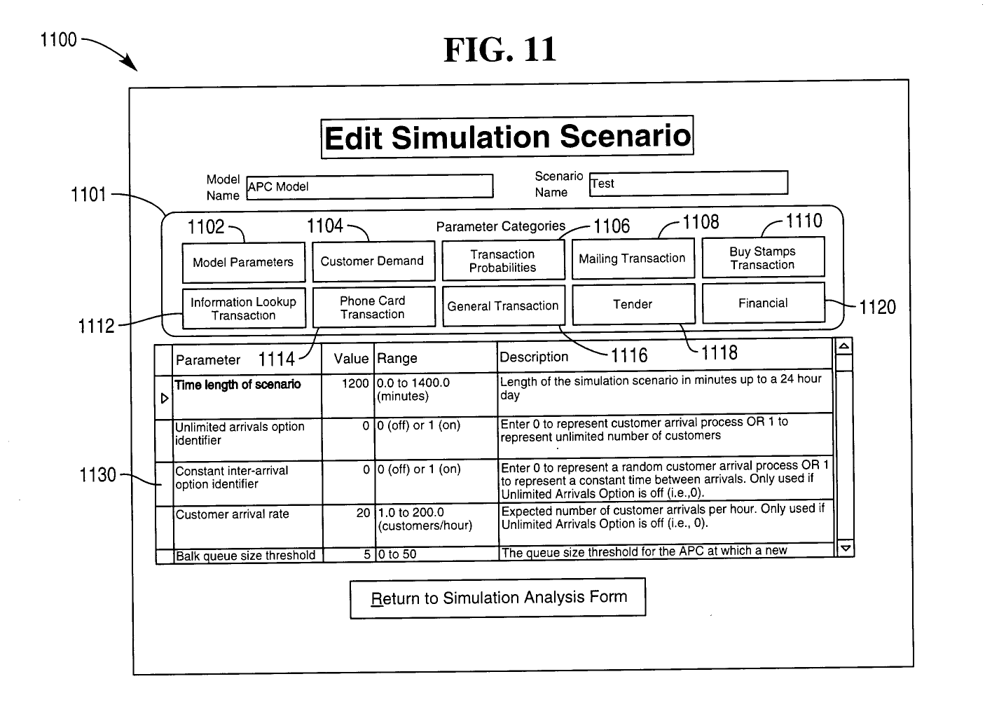

The Parameter Categories section 1020 is slightly different for APC models. FIG. 11 shows the Edit Simulation Scenario form 1100 for the APC model. The Transaction Probabilities and five APC transaction type categories replace the Transaction Characteristics, Labor Schedule, and Configuration categories. The Parameter Categories section 1101 includes a Model Parameters button 1102, a Customer Demand button 1104, a Transaction Probabilities button 1106, a Mailing Transactions button 1108, a Buy Stamps Transactions button 1110, an Information Lookup Transactions button 1112, a Phone Card Transactions button 1114, a General Transactions button 1116, a Tender button 1118, and a Financial button 1120. The Edit Simulation Scenario form 1100 also includes an edit table 1130 similar to the edit table 1010 of the Edit Simulation Scenario form 1000.

There are two approaches for editing a parameter's value(s) depending on whether the parameter has a single value (called a scalar parameter) or has multiple values (called a non-scalar parameter or an ARRAY). To edit the value for a scalar parameter, the user selects the cell in the Value column 1014 of the edit table 1010 for the parameter that the user wants to change and enters the new value. For example, to change the scenario Start Time parameter from 12 midnight (i.e., 0) to 7:30 am in FIG. 10, the user selects the cell containing the value of 6 and type in 7.5. Note the Start Time and End Time parameters are in units of hours from 12 midnight. When changing values, the user should make sure the new value is within the allowable range displayed in the Range column 1016 for the parameter. If the user enters a value outside the allowable range, the application will remind the user with a warning message. To edit the values for a non-scalar parameter, the user must click on the small rectangle icon 1050 just to the left of the Parameter field. Other Parameter fields have similar rectangular icons 1052, 1054, 1056 as depicted in FIG. 10. This action will invoke a new form allowing the user to edit each value for the parameter. A non-scalar parameter will have the word “Array” in the Value column.

In the POEM application, only the PO model has non-scalar parameters. The following is a list of the six non-scalar parameters:

1. Expected number of arrivals per hour in 15-minute intervals;

2. Balking probabilities for applicable resources;

3. Customer Decision Matrix (CDM);

4. Schedule of clerks to operate checkout counter;

5. Schedule of supervisors to assist checkout process, and;

6. Distribution of number of customer transactions for a customer.

After the User clicks on the rectangle icon adjacent to the left side of the Parameter column, the POEM application will open a new form that allows the user to modify the parameter's values. The next sections describe the edit forms for these non-scalar parameters.

Arrival Rate Schedule

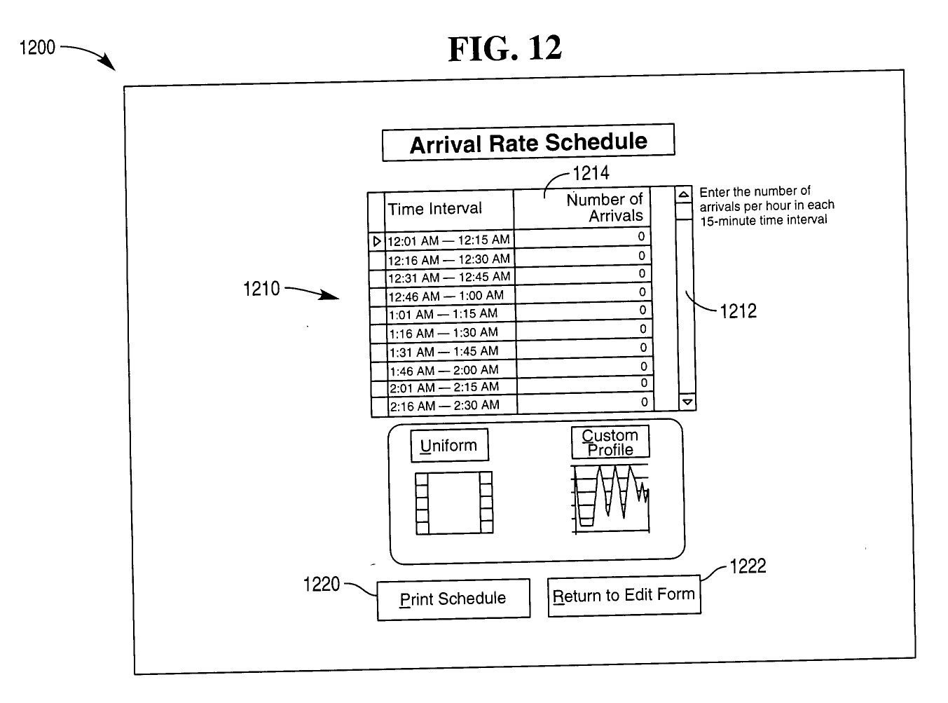

FIG. 12 is a depiction of an Arrival Rate Schedule form 1200 for editing the “expected number of arrivals per hour in 15-minute intervals”. The Arrival Rate Schedule form 1200 allows the user to change the values for the parameter that describes the rate at which customers arrive to the post office. The model uses these rates to randomly generate customer arrival times throughout the simulation scenario.

An edit table 1210 in the Arrival Rate Schedule form 1200 lists values from 12:01 am to 12:00 am in 15-minute intervals. To change a value, the user scrolls using a scroll bar 1212 to the time interval that the user wishes to edit, selects the corresponding cell in the Number of Arrivals column 1214, and enters the new value. The units for the values entered into this parameter are number of arrivals per hour in 15 minutes not the number of arrivals in 15 minutes.

The user must understand this important difference to prevent running a scenario with a different customer arrival pattern then the user intended to run. For example, if the user wants to represent 100 customers per hour from 9:00 to 9:30 am, and 150 customers per hour from 9:30 to 10:00 am, then the entries should be:

9:01-9:15 am 100

9:16-9:30 am 100

9:31-9:45 am 150

9:46-10:00 am 150

The model ignores values entered in the Number of Arrivals column 1214 before and after the time intervals specified by the Start Time and End Time parameters, respectively.

There are two options from this form, either Print Schedule button 1220 or Return to Edit Form button 1222. The Print Schedule button 1220 creates a report containing the arrival rate schedule and displays it on the screen. The user can then send the report to a printer or save it to a file in a variety of data formats. The Return to Edit Form button 1222 returns the user to the appropriate Edit Simulation Scenario form 1000 or 1100.

Balking Probabilities

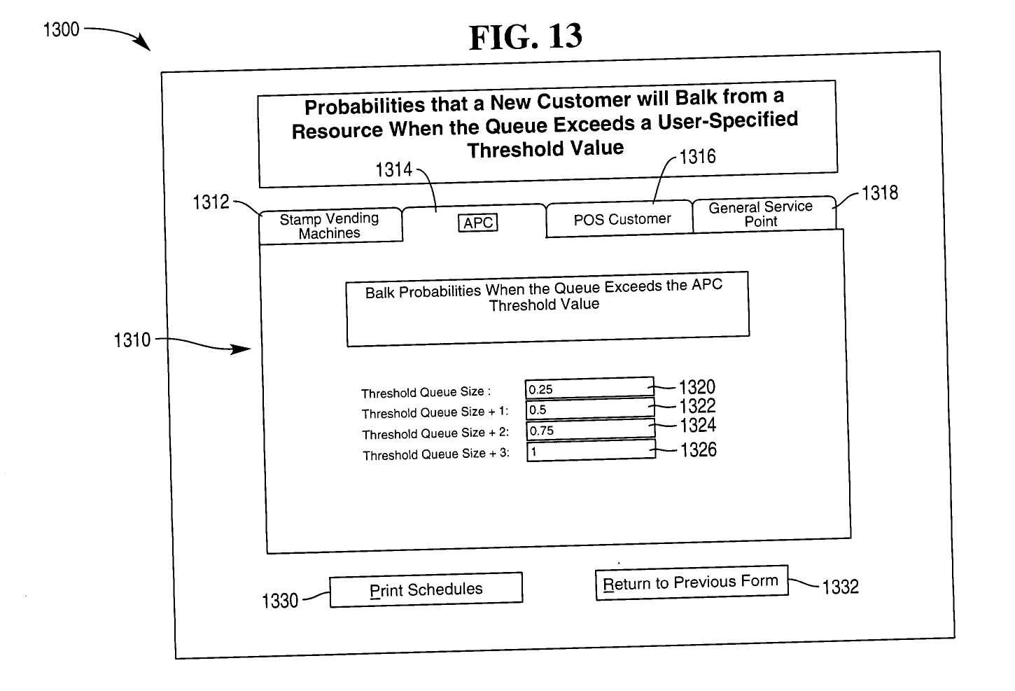

FIG. 13 depicts a Balking Probabilities form 1300 for editing the Balking Probabilities. The Balking Probabilities form 1300 allows the user to change the values for the parameter describing the likelihood that a customer will balk (leave without receiving service) from a resource when the queue reaches or exceeds a user-specified threshold value. In addition, the user may configure two separate scalar parameters to represent the likelihood that a customer who balks from the counter will go to APC and vice-versa. A customer that balks will leave the post office and the model increments the balk-counter used in the output report. A balked customer will not follow the logic for the next step indicated by the CDM.

The balk probabilities indicate the probability that a newly arriving customer will not join the queue when its size reaches the threshold queue size or greater. The Balking Probabilities form 1300 includes a Balk Probability tab sheet 1310 having tabs for individual balk probabilities 1312, 1314, 1316, and 1318. Each tab includes input fields for entry of balk probabilities similar to Threshold Queue Size entry field 1320, Threshold Queue Size+1 entry field 1322, Threshold Queue Size+2 entry field 1324, and Threshold Queue Size+3 entry field 1326. For example, assume there are 5 people waiting in line to use a APC and the APC threshold queue size parameter is set to 4 and the balk probabilities are those displayed in FIG. 11, i.e., entry fields 1320, 1322, 1324, and 1326. Then, say the next event is the arrival of a new customer who wishes to use the APC. In this case, the new customer would balk with probability 0.5. For this example, a customer would never balk if the queue size is less than 4 and the queue size would never exceed 7 (because the balk probability at Threshold Queue Size+3 is 1.0). In general, if the balking probabilities allow the queue size to get larger than the Threshold Queue Size+3, then the model would use the probability in this last cell for the probability that a customer balks.

Two important things to remember when modifying the balk probabilities:

1. The four probability entries in each tab do not need to sum to 1.

2. The only valid probability entries are between 0.0 to 1.0

Similar to the Arrival Schedule form 1200, there are two options from Balking Probabilities form 1300, either a Print Schedules button 1330 or a Return to Previous Form button 1332. The Print Schedules button 1330 creates a report containing the balk probabilities for all applicable resource types and displays it on the screen. The user can then send the report to a printer or save it to a file in a variety of data formats. The Return to Previous Form button 1332 returns the user back to the appropriate Edit Simulation Scenario form 1000 or 1100.

Customer Decision Matrix

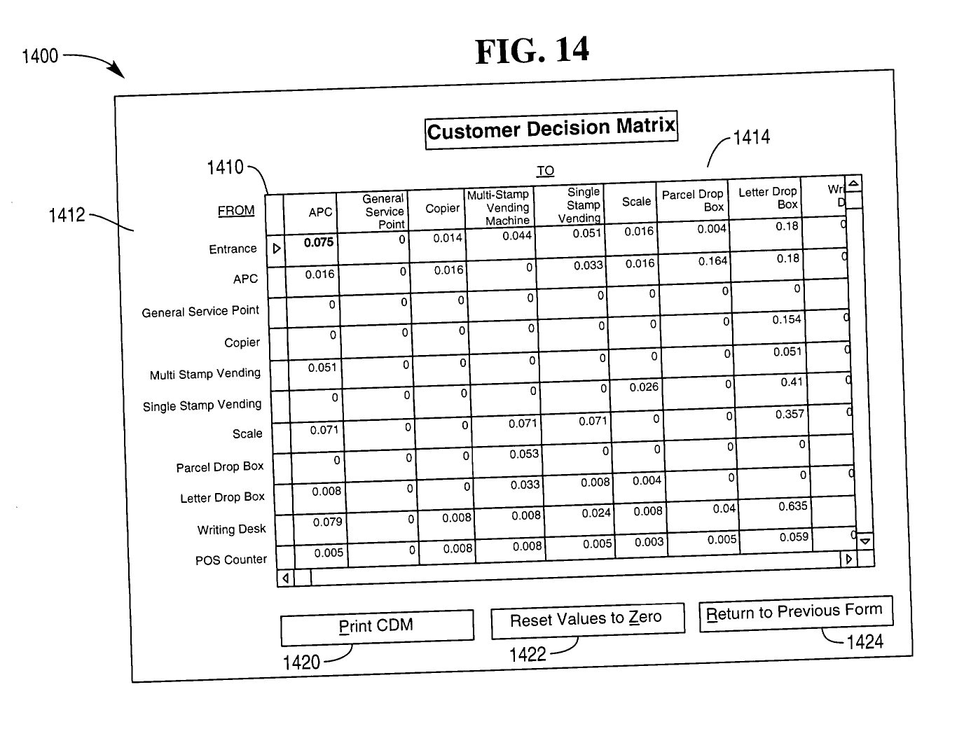

FIG. 14 depicts a Customer Decision Matrix form 1400 used to edit the Customer Decision Matrix parameter. This parameter defines the probability a customer visits a particular sequence of service points when they enter the post office. The logic represented by this approach is referred to as probabilistic routing. The logic specified in the CDM indicates the probability a customer goes from a “row” location to a “column” location. The probabilities are captured in a CDM probability table 1410 having a series of “from” rows 1412 and “to” columns 1414. For example, FIG. 14 depicts that a customer who enters the post office (row 1) has a 7.5% chance of going directly to a APC, 1.4% chance of going directly to a copier, 4.4% chance of going to a multiple-stamp vending machine, etc. If a customer goes to a APC (row 2), then there is a 1.6% chance of going to the APC next, a 1.6% chance of going to the copier, and so forth. Eventually, the customer will go to the exit point and depart the post office.

Two important things to remember when modifying the CDM:

1. The row probabilities must sum to 1.

2. The only valid entries for a cell are between 0.0 to 1.0

The current version of the POEM checks to make sure the rows sum to one and will issue a warning message if they do not. If this occurs, then the user will have to make the necessary corrections.

FIG. 14 shows the default scenario CDM entries in the CDM probabilities table 1410 for the PO model.

There are three options from the Customer Decision Matrix form 1400, a Print CDM button 1420, a Reset Values to Zero button 1422, or a Return to Previous Form button 1424. The Print CDM button 1420 creates a report containing the CDM and displays it on the screen. The user can then send the report to a printer or save it to a file in a variety of data formats. The Reset Values to Zero button 1424 replaces all probability values with zero, with the exception of the last column, Exit, which is set to one (to satisfy property #1 above). The Return to Previous Form button 1426 returns the user back to the appropriate Edit Simulation Scenario form 1000 or 1100.

Personnel Schedules

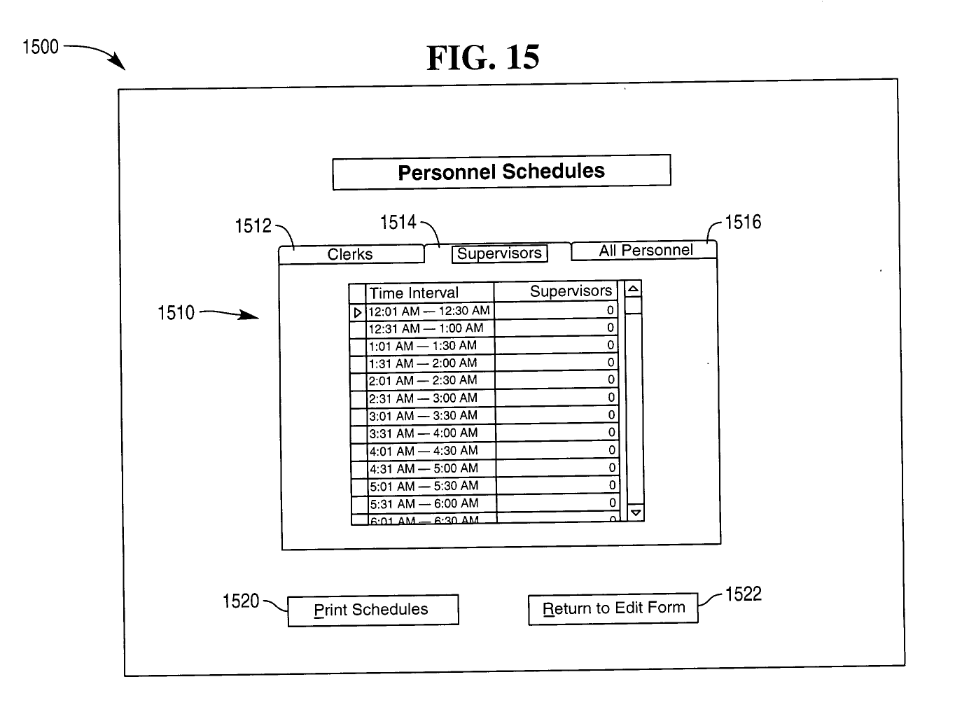

FIG. 15 depicts a Personnel Schedules edit form 1500. The Personnel Schedules form 1500 enables the user to enter the number of post office personnel available by personnel type in 30-minute time intervals for a scenario using an edit table 1310. The two types of personnel the user can schedule are clerks and supervisors as indicated by a clerks tab 1512 and a supervisors tab 1514. All personnel can be scheduled using the all personnel tab 1516.

FIG. 15 depicts the current active parameter is the “Schedule of supervisors”. After the user enters this form from the Edit Simulation Scenario form 1000 for either clerks schedule or supervisors schedule parameters, the user can edit the values for the other parameter by selecting the corresponding parameter tab 1512, 1514, 1516. The tab labeled All Personnel displays an edit table for both parameters at the same time.

The PO requires that at least one clerk, and if intervention event is possible, at least one supervisor, are available throughout a scenario; otherwise, the only other requirement is the user should enter only nonnegative integer values. The model ignores values entered in the schedules before and after the time intervals indicated by the Start Time and End Time parameters, respectively. Also, the user should not enter a value in a schedule larger than the number of counter positions. For example, if the number of counter positions is 2, then entering a value greater than two in the “Schedule of cashiers” will result in the same performance as entering a value of two. The only difference is that the user has more scheduled clerk time in the output report.

After the user finishes editing the values in this form, the user can select one of two options, either a Print Schedule button 1520 or a Return to Edit form button 1522. The Print Schedule button 1520 creates a report containing the schedules for both parameters by time of day and displays it on the screen. The user can than send the report to a printer or save it to a file in a variety of data formats. The Return to Previous Form button 1522 returns the user back to the appropriate Edit Simulation Scenario form 1000 or 1100.

Distribution of Items Purchased

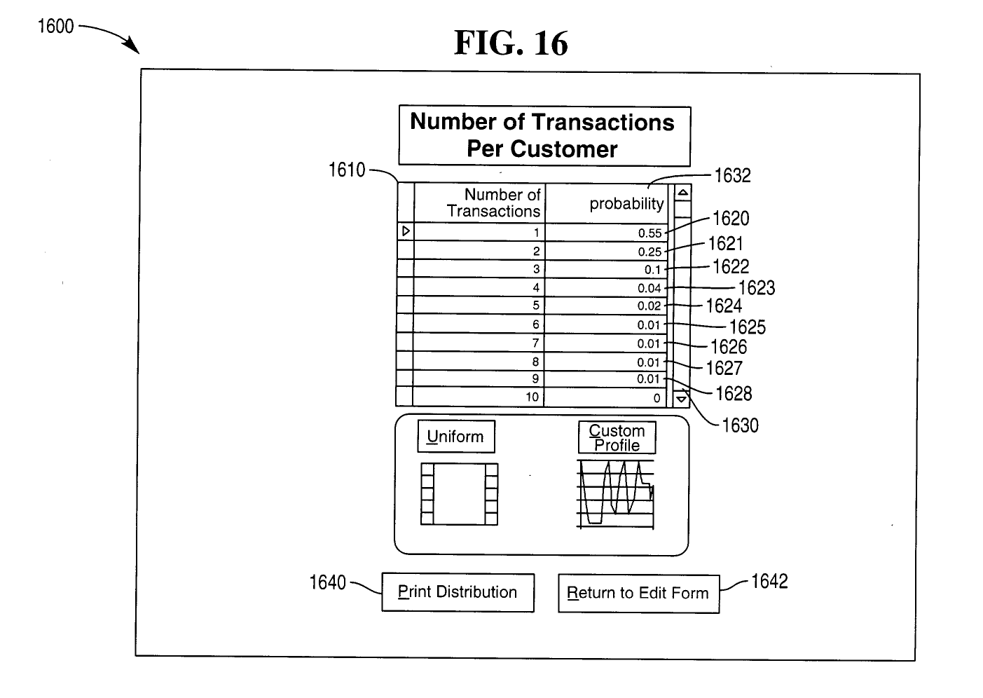

A Distribution of Items Purchased form 1600, as shown in FIG. 16, enables the user to enter values for the parameter specifying the probability of the number of transactions, e.g., buy stamps, send mailpiece, post office box rental, etc., a customer performs at the counter during their visit to the counter. The model uses these values to randomly generate the number of items for each customer.

FIG. 16 shows the edit form for the “Number of Transactions Per Customer” parameter including an edit table 1610. In this example, a customer can perform 1, 2, 3, 4, 5, 6, 7, 8, or 9 transactions with probability 0.55, 0.25, 0.1, 0.04, 0.02, 0.01, 0.01, 0.01, and 0.01, as indicated by edit table entries 1620-1628, respectively. The “Number of Transactions Per Customer” parameter refers to counter transactions only.

To change a value in the Distribution of Items Purchased form 1600, simply scroll using scroll bar 1630 to the number of items that the user wish to edit, select the corresponding cell in a Probability column 1632, and enter the new value. Similar to other probability forms, the valid entries in the probability column are between 0.0 and 1.0, and the column sum must be 1.0.

Similar to previously described edit forms 1300, 1400, and 1500, there are two options from the Distribution of Items Purchased form 1600, either a Print Distribution button 1640 or a Return to Edit Form button 1642. The Print Distribution button 1640 creates a report containing the numbers of items purchased and their probabilities, and displays it on the screen. The user can than send the report to a printer or save it to a file in a variety of data formats. The Return to Previous Form button 1642 returns the user back to the appropriate Edit Simulation Scenario form 1000 or 1100.

Delete Parameter File

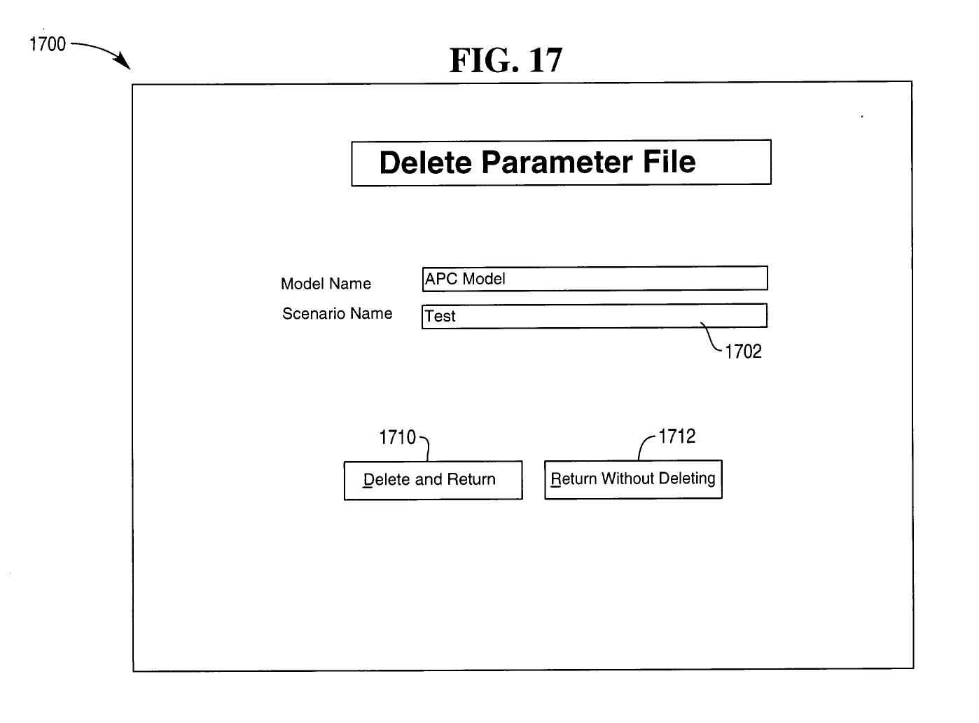

The user can delete scenario files by selecting the scenario on the Simulation Analysis or Financial Analysis Module forms 700 and selecting the Delete Scenario button 738. Performing this action will cause a Delete Parameter File form 1700 to be displayed as depicted in FIG. 17. In FIG. 17, the user is about to delete a scenario called “Test”, as indicated in Scenario Name field 1702, created for the PO model.

There are two options from the Delete Parameter File form 1700: a Delete and Return button 1710 and a Return Without Deleting button 1712. If the user selects Delete and Return button 1710, then the POEM opens a window which prompts the user to confirm their request to delete the scenario file. Selecting OK to the confirmation will delete the scenario file and return the user to the Simulation (or Financial) Analysis Module form 700. Selecting CANCEL on the confirmation will return the user to the Delete Parameter File form 1700 without deleting the file. The Return Without Deleting button 1712 returns the user to the Simulation Analysis Module form 700, or Financial Analysis Module form 700, without deleting the scenario file. Remember that the user cannot delete a model's Default scenario, so the only option the POEM will allow the user to select in the Delete Parameter File form 1700 displayed in FIG. 17 is Return Without Deleting button 1712.

Print Scenario

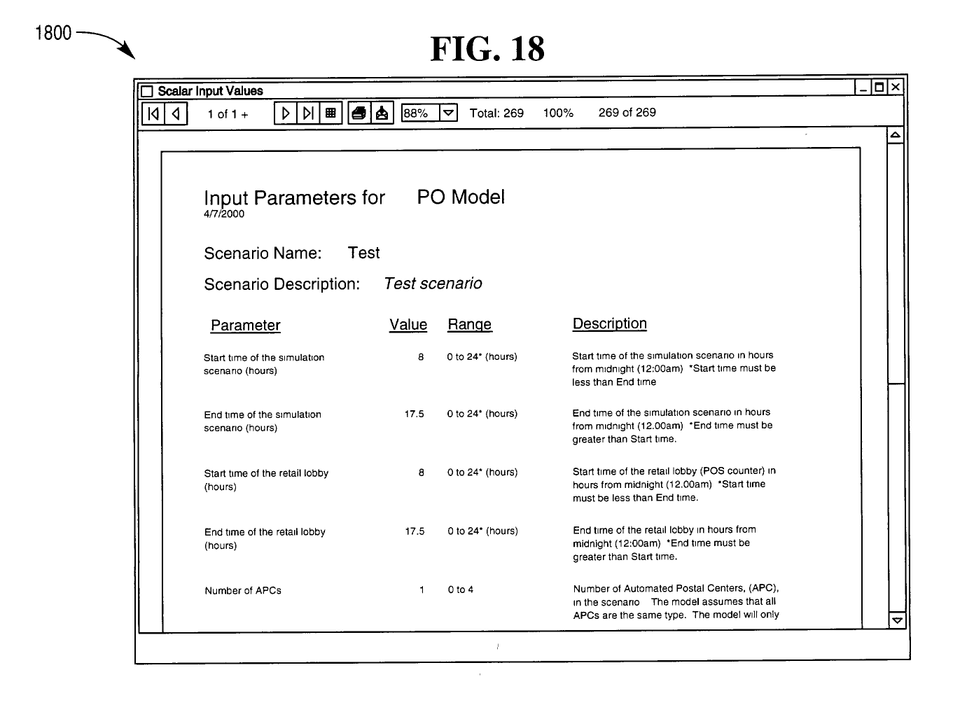

The user can display a model's DID by selecting the Print Scenario button 736 from the Simulation Analysis or Financial Analysis Module forms 700. FIG. 18 depicts the first page of the DID for the post office model. The user can use the control buttons at the top of this window to

1. Page through the report;

2. Print the report to the default printer, or;

3. Save the report to a disk file in the name of the user's choice and in a variety of data formats.

After finishing with the DID report, the user can close the report window as the user would with any other window, e.g., click on the “X” icon in the upper right hand corner.

The Print Scenario button 736 from the Simulation Analysis and Financial Analysis Module forms 700 will create and display a report of only a model's scalar parameters and their values. To generate a report containing the values for non-scalar parameters, the user needs to select the print option button on the non-scalar parameter edit form. For example, selecting the Print Schedules button 1520 from the Personnel Schedules edit form 1500 will print the values for these parameters. Recall, only the PO model contains non-scalar parameters.

Running Simulation

The user can run a simulation model from the Simulation Analysis Module form 700. The user selects the model and scenarios the user wants to run and starts the simulation by selecting the Run Simulation Analysis button 742. Checking the Animation checkbox 748 below the Run Simulation Analysis button 742 will turn on the animation.

Animation Mode

New users are advised to first run a simulation scenario with the animation on. This will help users become familiar with the models and DID parameters. The animation will help, in many cases, to visually confirm the scenario that the user wishes to run is actually the one they are running. That is, the user did not set an input parameter value incorrectly.

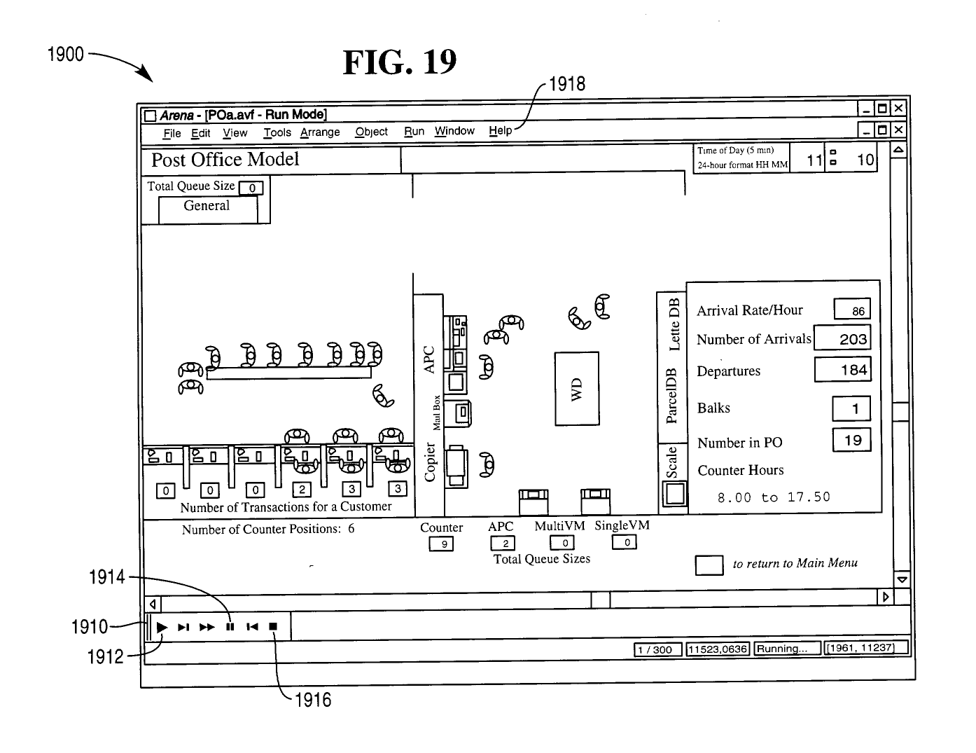

To run a model with the animation on, the user checks the animation checkbox 748 before selecting the Run Simulation Analysis button 742. This action launches an application from System Modeling Corporation called Arena Viewer™, loads the model, and starts to run the scenario. FIG. 19 depicts the animation overview screen 1900 of the PO.

In animation mode, the user controls the model execution using either the file menu options or a button menu bar. The set of buttons on the button menu bar control the scenario execution and include a Go (start a model) button 1912, a Pause button 1914, and an End button 1916. These buttons appear on the menu bar 1910 at the lower left of the window of the screen 1900. The user can learn more about the Arena Viewer™ features using a Help file menu 1918.

In animation mode, the model scenario will start running, i.e., Go, automatically. To pause the model, the user needs to click on the Pause button 1914, i.e., the button with two vertical lines, “∥” The user may want to pause a model, for example, to describe the scenario to their audience or check to make sure the scenario status variables displayed on the screen appear correct. When the user is ready to start the model again, they select the Go button 1912, i.e., the right arrow button, “≮”. To end the scenario, the user needs to click on the Pause button, “∥”, and then the End button, i.e., the button with a rectangle. The user can restart the model after a Pause or begin it again after they select the Pause and End buttons, by selecting the Go button. When the user finishes demonstrating the model or is confident the model scenario appears correct, the user needs to End the simulation scenario, close the Arena Viewer™ application, and return to the POEM application. The simplest method to close the Arena Viewer™ application is to click on the X icon in the upper right hand corner of the screen.

Another important reason to first run a model scenario in animation mode is the simulation models perform additional checks on whether the parameter values for a scenario are feasible or not. If an error is found, the model will stop prematurely (i.e., before the model completes the specified number of replications). If the model stops, Arena Viewer™ will display a window asking if the user would like to see the model's results. Answer Yes to this prompt and a window displaying a text file will display on the screen. The first line of this text file will contain an error message that indicates why the model stopped. Take note of the error message, close the text file window, close the Arena Viewer™, and go into the Simulation Analysis Module and make the correction to the input scenario indicated by the error message. If the user is unable to correct the error, copy the error message into an email and send it to the technical support email address provided in the Introduction section. If the user is in animation mode and the model scenario runs to completion, then click the No button on the prompt to see the model's results, close the Arena Viewer™ application, and go into the Output Module to see the results.

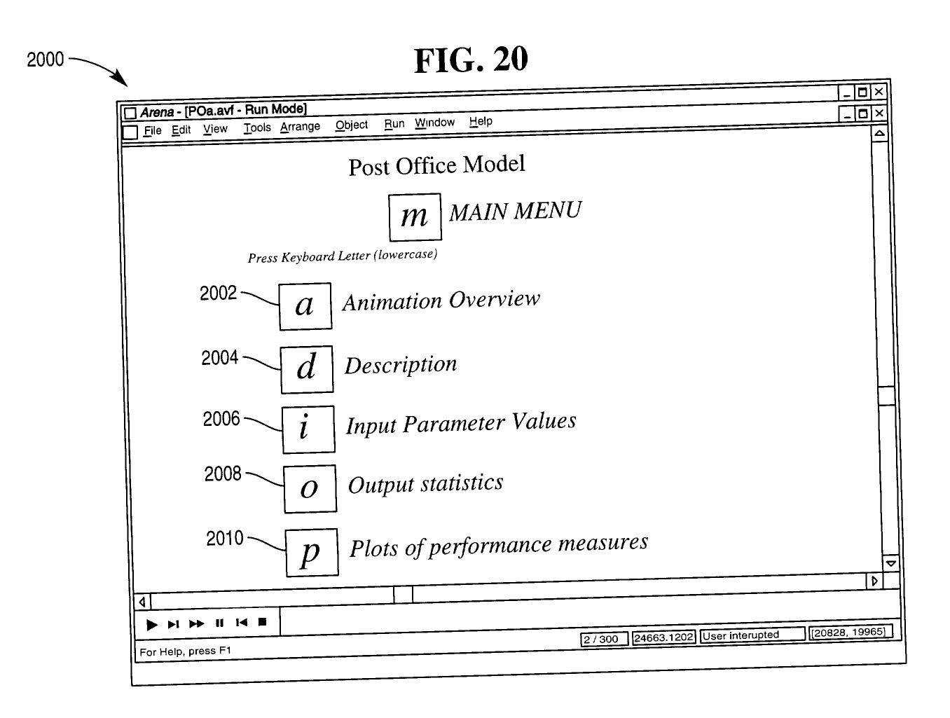

The present invention also sets up several screen views in each of the simulation models to help the user better understand and communicate the model's results. The user can display these screen views only when a model is run in animation mode. Arena Viewer™ lists the screen views for each model when the user presses the “m” key (lower case) on the keyboard. FIG. 20 depicts a Main Menu form 2000 including buttons, i.e., an animation overview button 2002, a description button 2004, an input parameter values button 2006, an output statistics button 2008, and a plots of performance measures button 2010, providing access to the screen views available in the PO model.

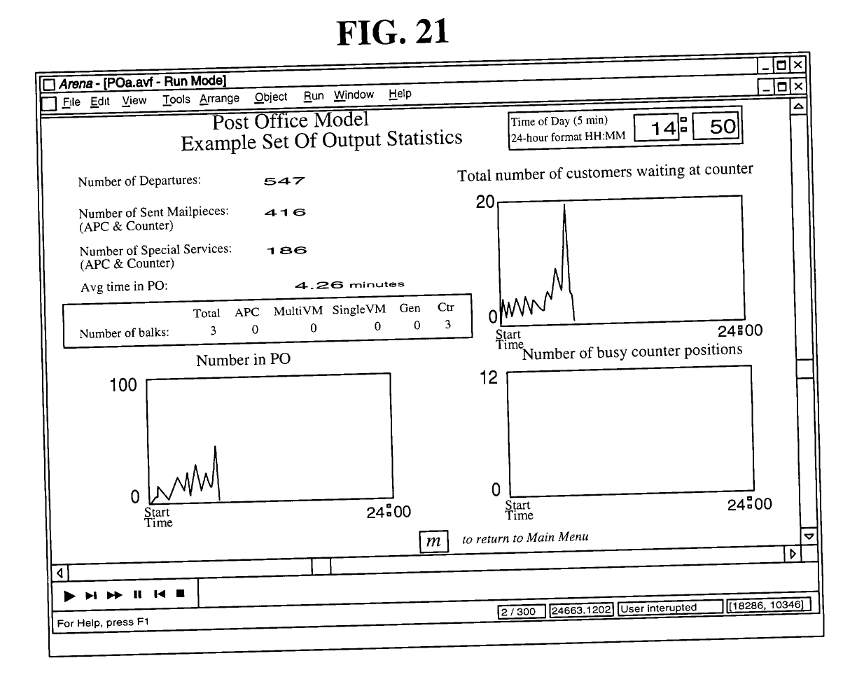

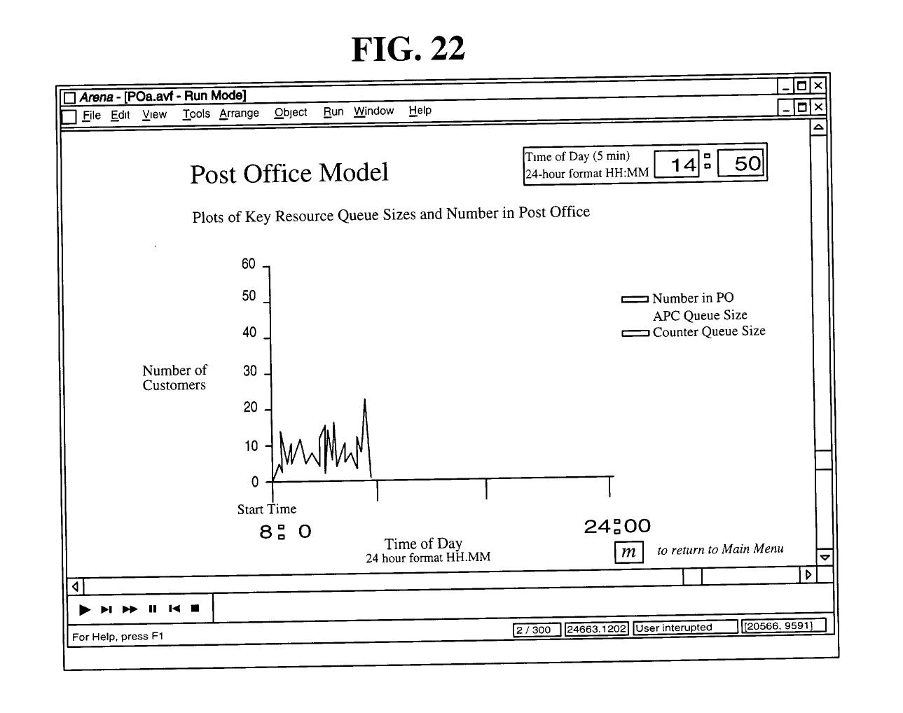

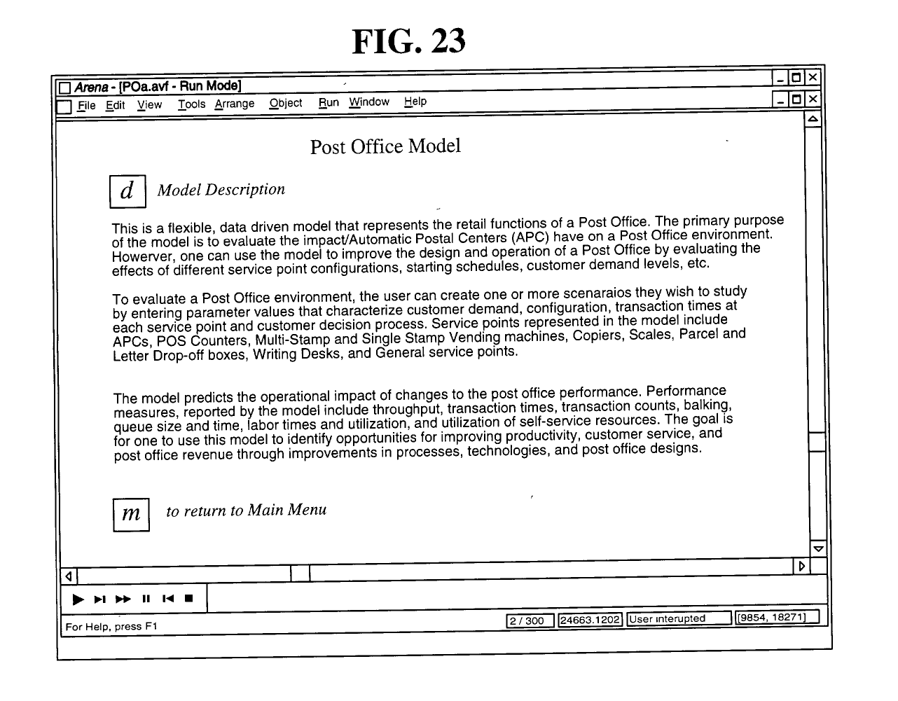

The user can switch between screen views by entering the lower case letter corresponding to the screen view title. For example, pressing the “a” key 2002 switches the view back to the animation overview screen displayed in FIG. 19. FIG. 21 depicts the screen view displayed when pressing the “o” key 2008. This screen depicts the current value of some of the output performance measures reported by the model. FIG. 22 depicts a graph with a plot of Number of Customers in Store versus Time of Day. FIG. 23 depicts a screen view that gives a summary description of the model.

Analysis Mode

When the user is ready to run simulation experiments to analyze the impact of certain design, procedure, or technology changes on APC or post office performance, the user should do so with the animation off. This mode of running scenarios is referred to as the analysis mode. When the animation is off, the models execute much faster allowing the user to conduct more statistically sound experiments. The POEM can also evaluate many more scenarios in a shorter time period.

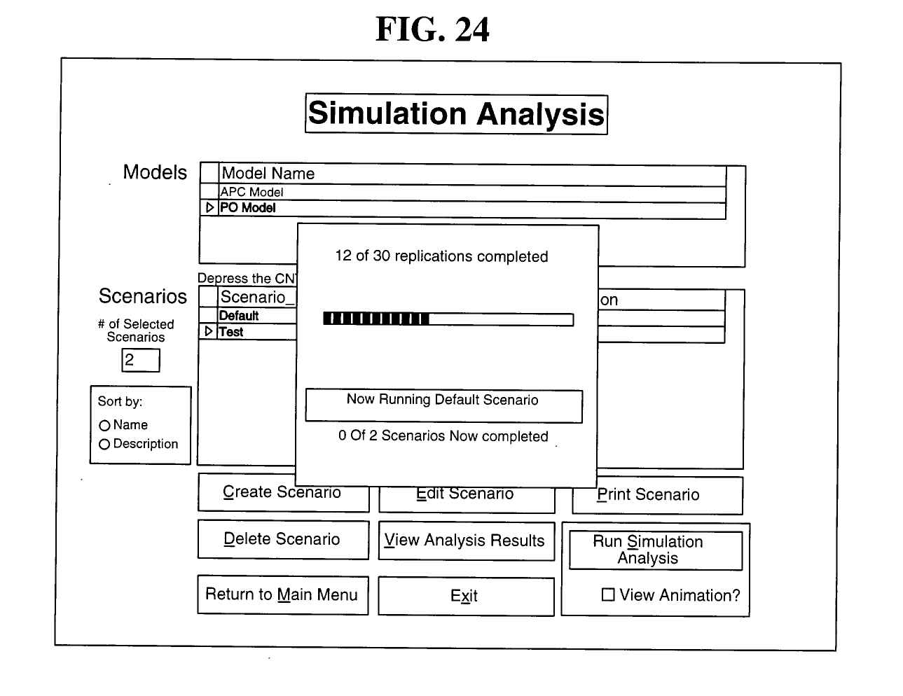

To run a scenario in analysis mode, the user selects the Run Simulation Analysis button 742 on the Simulation Analysis Module form 700 with the Animation checkbox 748 left unchecked. After a slight delay to initialize the model, a window will appear displaying the current number of replications completed out of the total number of replication the user specified in the input parameter “Number of simulation replications”. For example, FIG. 24 illustrates the model has processed 12 out of the 30 replications for this scenario, which is the first of the two scenarioes selected.

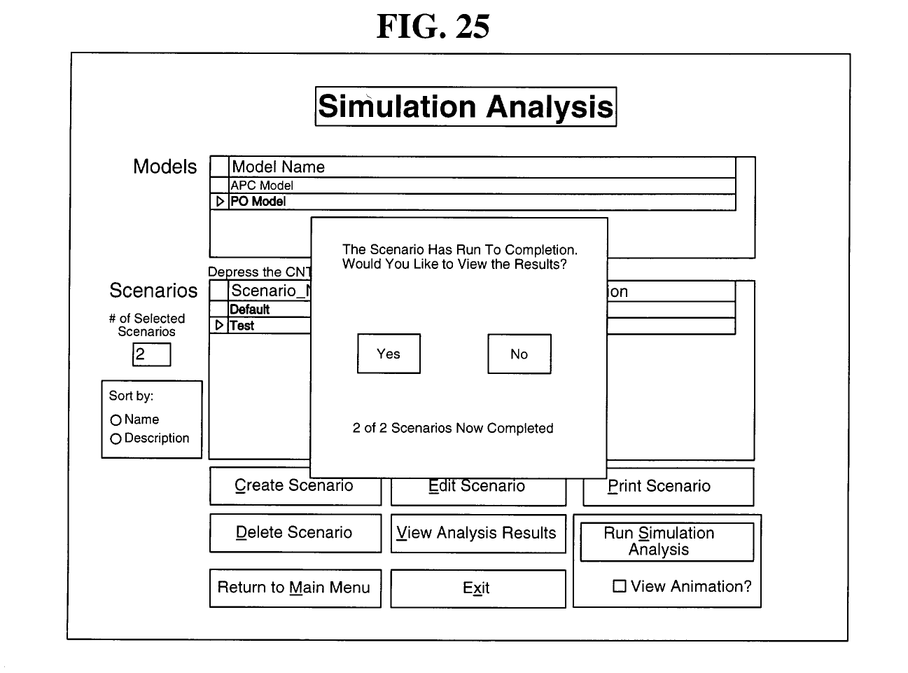

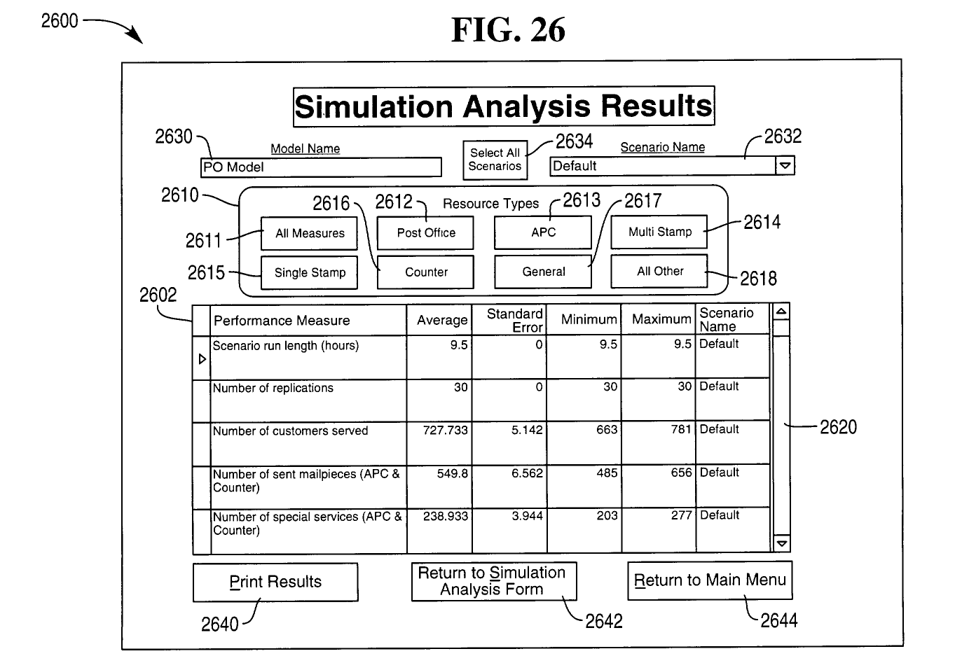

As depicted in FIG. 25, when the model completes all the replications, the POEM will display a window to ask if the user would like to see the results. Selecting Yes will cause the POEM to display the Output Module form 2600 as depicted in FIG. 26 described below. Selecting No will return the user to the Run Simulation Module form 700.

Simulation Output

Each of the simulation models in the POEM has its own set of output performance measures. These measures include throughput, transaction times, queue sizes and times, resource utilization, and customer times.

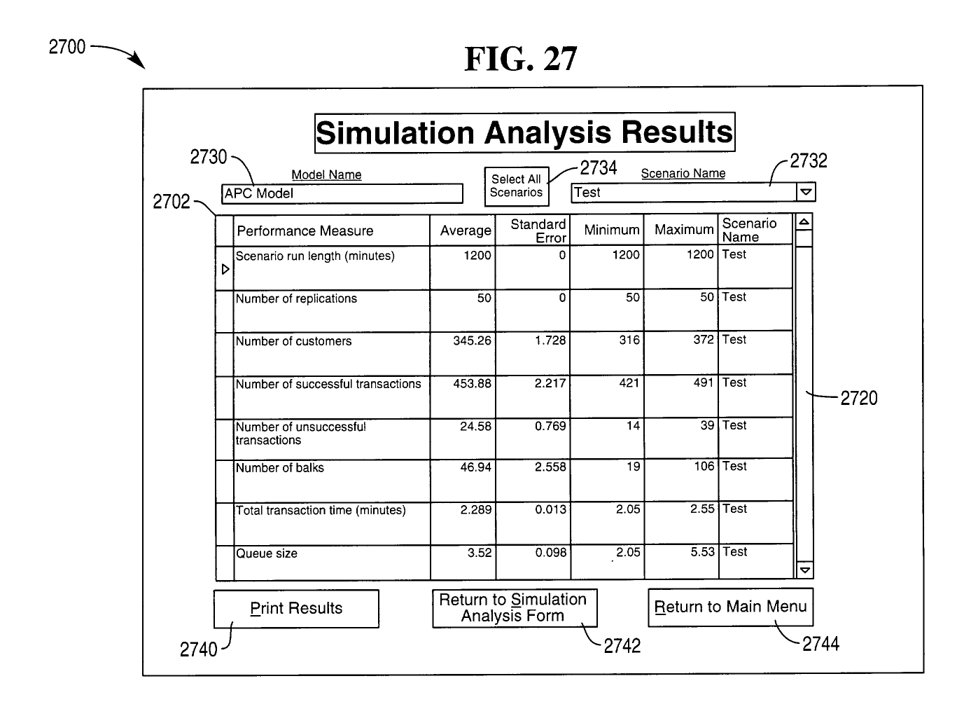

FIGS. 26 and 27 show the Output Module forms 2600, 2700 for the PO and APC models, respectively, and include a performance measure table 2602, 2702. The difference between the Output Module forms 2600, 2700 is the PO model set includes a Resource Types section 2610 having Resource Type filter buttons, i.e., an All Measures button 2611, an Post Office button 2612, a APC button 2613, a Multi Stamp button 2614, a Single Stamp button 2615, a Counter button 2616, a General button 2617, and a All Other button 2618, for different sets of performance measures and the APC model does not. These buttons 2611-2618 allow the user to display only particular performance measure types, e.g., Counter button 2616 displays performance measures associated with POS counters. To view the report, the user scrolls the table using the scroll bar 2620, 2720 to the right of the performance measures table 2602, 2702. To view a particular performance measure set, click the performance measure button in the Resource Type section 2610.

The Output Module forms 2600, 2700 also display the Model Name in a Model Name field 2630, 2730 and Scenario Name in a Scenario Name field 2632, 2732. If the user runs a batch of more than one scenario, then there will be a list of scenario names in the Scenario Name drop-down window from which they can choose to display the results in the table. Selecting a Select All Scenarios button 2634, 2734 will display the results for all scenarios run in the batch. The table entries in performance table 2602, 2702 will be grouped by performance measure.

The performance measure table 2602, 2702 contains estimates for the average, standard error, minimum, and maximum value for each performance measure. The minimum and maximum values are the minimum and maximum values of the summarized performance measure at the end of a replication and not necessarily the minimum and maximum value during a replication. The standard error statistic provides a measure of error for how well the average value reported by the model estimates “the true” average value. In general, the user can view “the true” average value to fall within plus or minus two times the standard error value around the estimated average.

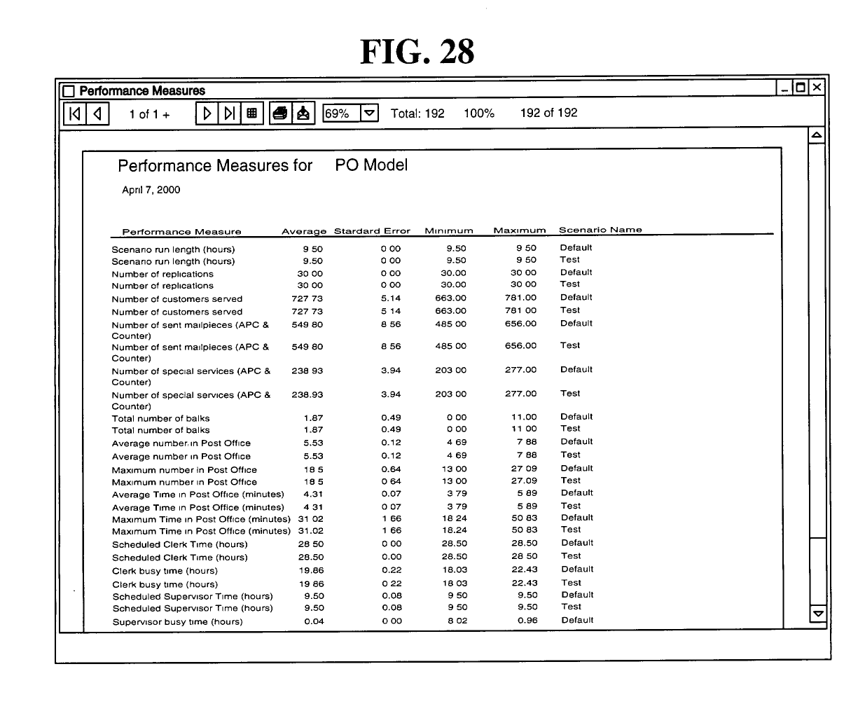

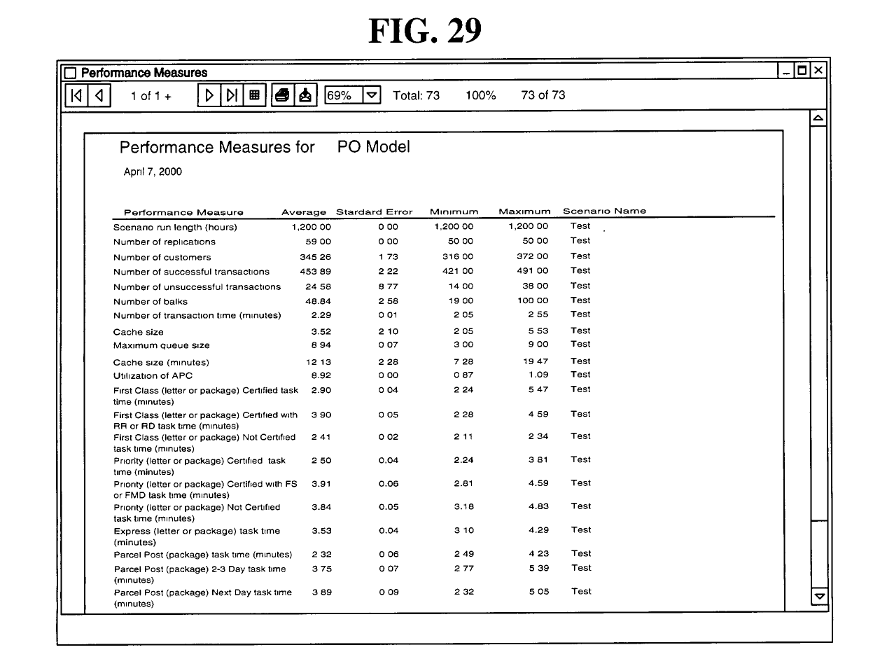

An alternative way to view a performance measures report is to select a Print Results button 2640, 2740. This action creates a performance measures report document and displays it on the screen. FIGS. 28 and 29 depict the reports for the PO and APC models, respectively. The user can use the control buttons at the top of these forms to page through the report, print it, or save it to a disk file in various data formats.

The other two options for the Output Module form 2600, 2700 are a Return to Simulation Analysis Form button 2642, 2742 and a Return to Main Menu button 2644, 2744.

The POEM does not save simulation results from previous simulation runs. So, the user will need to send the report to a printer or write it to a file to retain the results each time they run a scenario. Writing the report to a file and reading it into a spreadsheet application such as Excel™ or Lotus™ makes it easier to consolidate output reports comparing system performance across simulation scenario.

Financial Analysis Module

An analyst can use the Financial Analysis Module as a separate analysis tool or in conjunction with the Simulation Analysis Module. When used separately, an analyst enters the financial parameter values along with the expected transaction volume by transaction type for the analysis. When used with simulation, the financial analysis uses the transaction volume results from the corresponding simulation scenario to perform the analysis.

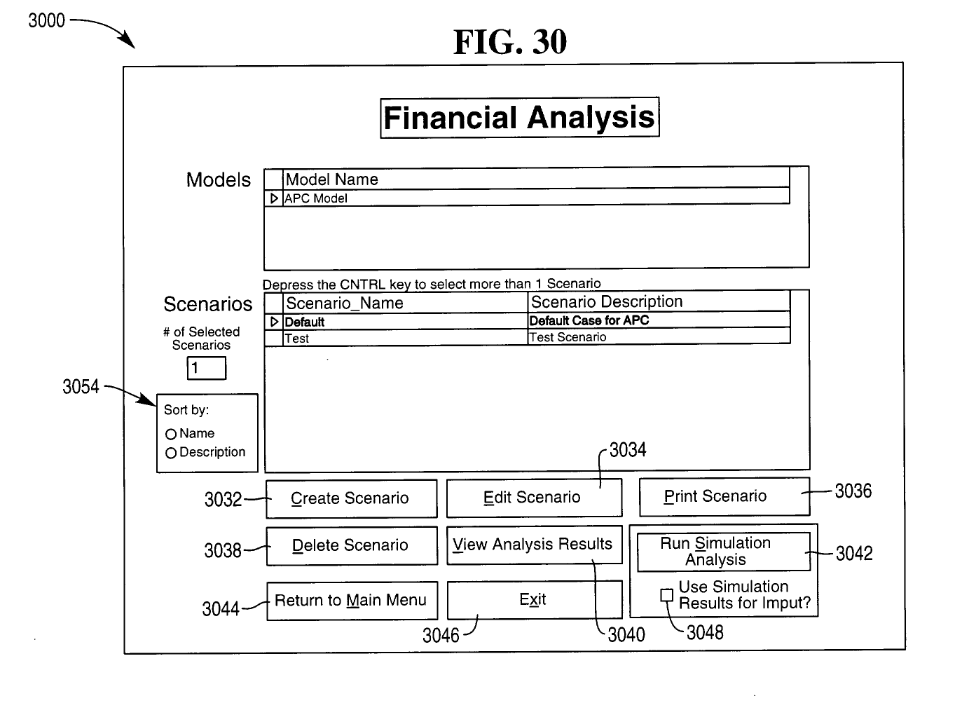

FIG. 30 depicts the Financial Analysis form 3000 which is similar to the Simulation Analysis form 700 in appearance and functionality. That is, users can create, save, edit, delete, print and run one or more input parameter files to shows the financial impact of one or more APCs. A Create Scenario button 3032, an Edit Scenario button 3034, a Print Scenario button 3036, and a Delete Scenario button 3038 perform the same parameter file operations as described in conjunction with the Simulation Analysis form 700. These features are described in the corresponding description of the Simulation Analysis form above. The Financial Analysis form 3000 also includes a View Analysis Results button 3040, a Run Financial Analysis button 3042, a Return to Main Menu button 3044, and an Exit button 3046 which behave similar to the corresponding buttons 740, 742, 744, and 746 of the Simulation Analysis form 700. The Financial Analysis form 3000 includes a Use Simulation Results For Input checkbox 3048 described in detail below.

A APC model scenario created in the Financial Analysis Module will also appear in the Simulation Analysis Module (and vice-versa). However, the user will only be able to edit a scenario's financial analysis parameters while in the Financial Analysis Edit Scenario form and the scenario's simulation parameters in the Simulation Analysis Edit Scenario form. Displaying the APC model scenarios in both modules allows the user to link the financial analysis to the corresponding simulation scenario results.

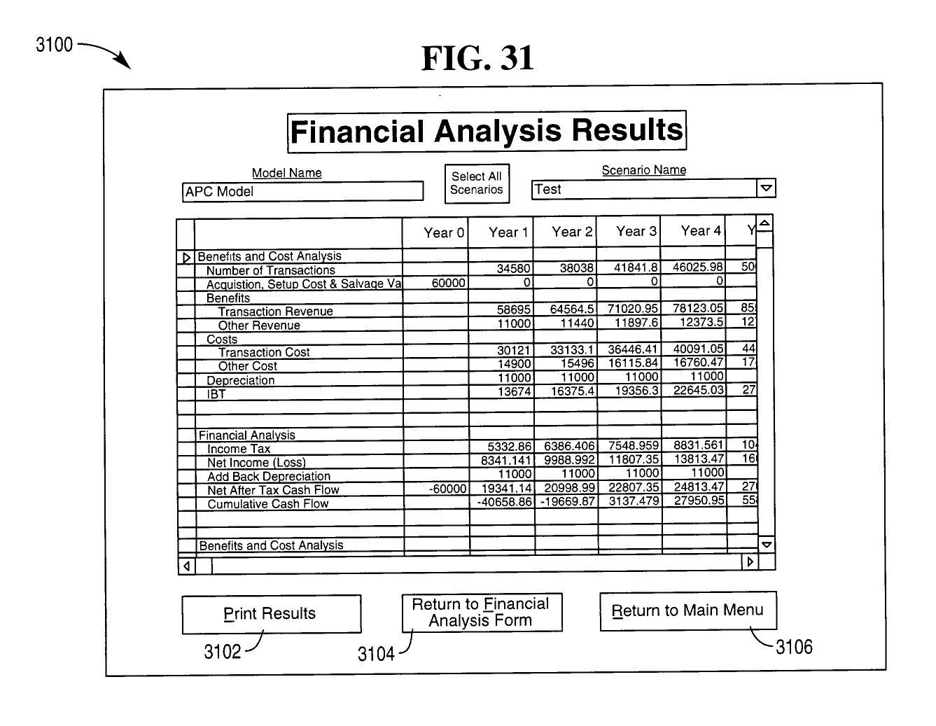

To run a financial analysis, the user needs to select one or more scenario files and click the Run Financial Analysis button 3042. The financial calculations run very fast and the application prompts the user to view the results as soon as the application completes the analysis. If the user responds yes to the prompts, the application displays the Financial Analysis Output form 3100 similar to the one shown in FIG. 31. If the user responds no to the prompt when the analysis is finished, the user may still view the results by selecting the View Analysis Results button 3040. Remember that the application only retains the results for the last analysis run. If the user checks the Use Simulation Results for Input checkbox 3048 before running the financial analysis, the application will run the corresponding simulation scenario(s) for the APC model first and use those results in the financial analysis. The user should be careful that all simulation scenarios run individually or in a batch are feasible scenarios, i.e., scenarios that run successfully and are terminated upon completion at the end of the simulation run. If a scenario is not feasible, and terminates prior to completing the first replication, then the application will use the results from the previous scenario for generating the performance measures report. Scenarios terminating after the first replication and before the end of the simulation may cause the application to close or provide unreliable results.

The last two options from the Financial Analysis form 3000 are Return to Main Menu button 3044, which returns the user to the main menu 600 (shown in FIG. 4), and Exit button 3046, which closes the application.

Similar to the Simulation Analysis Module, the Financial Analysis Module allows the user to create numerous scenario (assuming the user has adequate hard disk space available) files for the APC model. The user can sort the list of scenarios by name or description by selecting the corresponding radio button in a Sort By section 3054.

When installed, the POEM contains one Default scenario for the APC model in the Financial Analysis Module. The values in the Default scenarios are from industry composite data collected and summarized. The user will not be able to delete or change any parameter values on the Default scenarios. These operations can only be performed on scenario files created by the user.

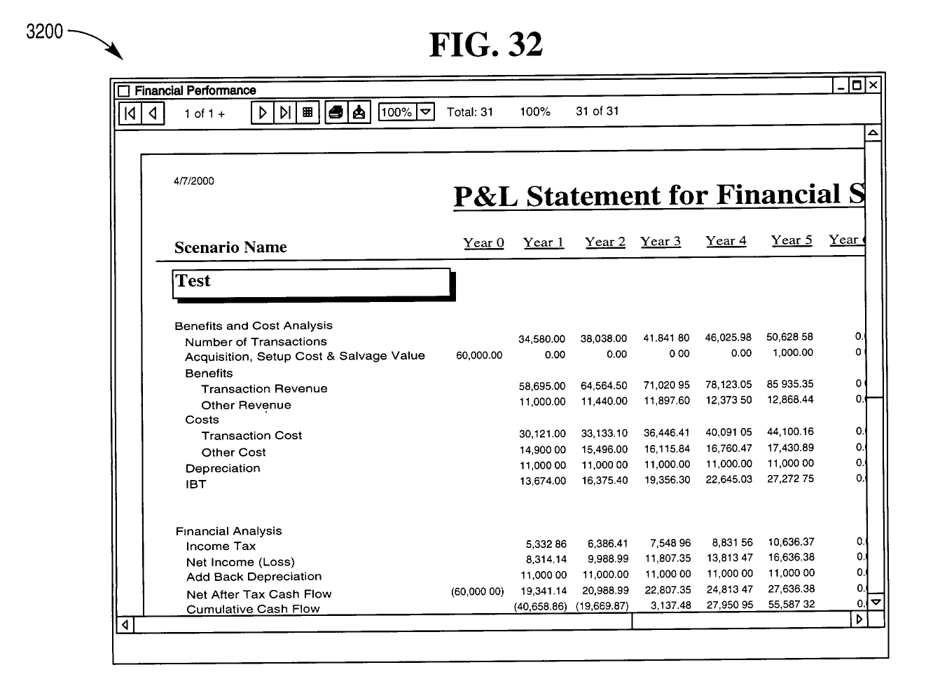

The application displays the Financial Analysis Results in the form of a standard profit and loss (P&L) statement 3200 as depicted in FIG. 32. The P&L statement 3200 consist of three sections. The first section shows the total annual number of transactions, benefits (revenue), and costs for the APC(s). The second section shows the annual cash flows after accounting for the effects of depreciation and taxes. The final section contains the number of APCs, NPV, IRR, and approximate payback for the after tax cash flows in section two. Users enter the number of years to include in the financial analysis.

An alternative way to view the output report is to select a Print Results button 3102. This action creates a performance measures report document and displays it on the screen. FIG. 32 illustrates the P&L report 3200. The user can use control buttons at the top of form 3200 to page through the report, print it, or save it to a disk file in various data formats.

The other two options for the Financial Analysis Result form 3100 are Return to Financial Analysis Form 3104 and Return to Main Menu 3106.

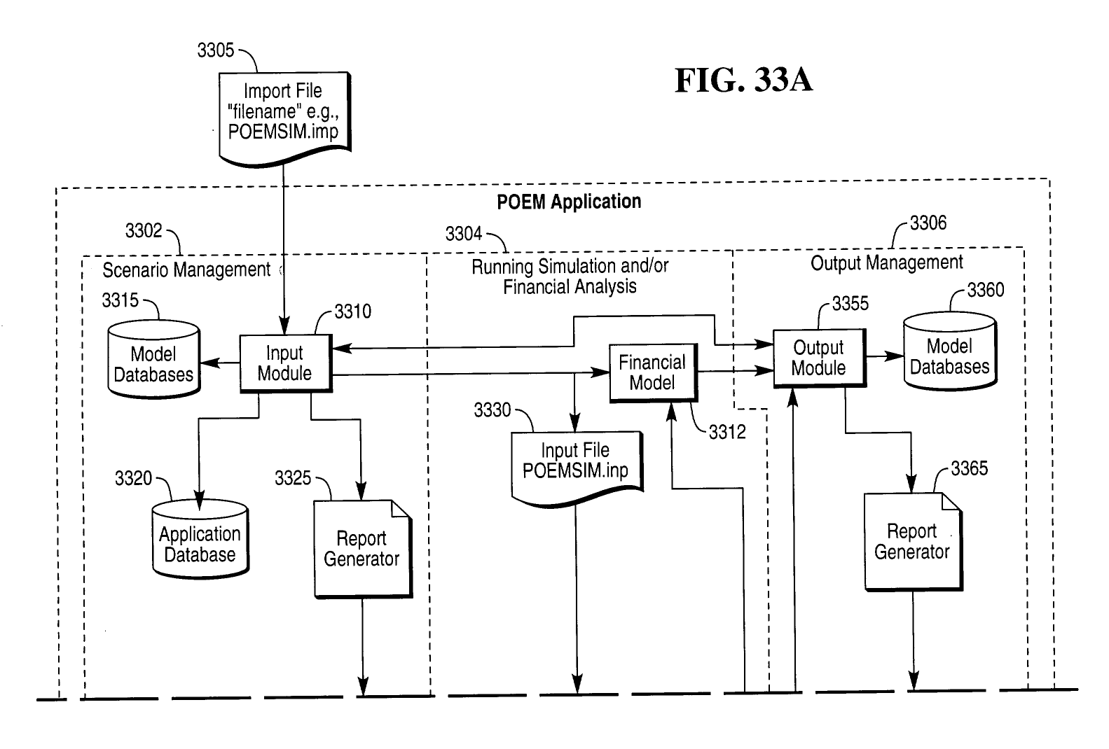

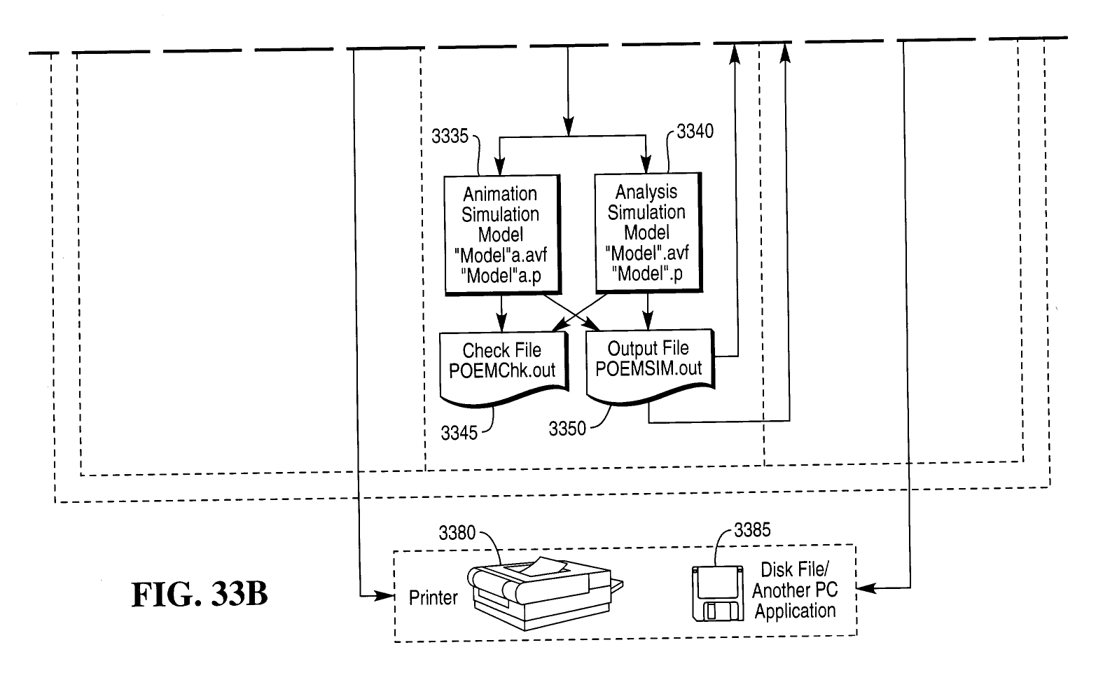

As depicted in FIG. 33, a logical architecture for the POEM simulation model is illustrated. As depicted in FIG. 33, an import file 3305 is provided to an input module 3310. As depicted in FIG. 33, there is a scenario management section 3302, a running simulation section 3304 and an output management section 3306. The input module 3310 straddles both the scenario management section 3302 and the running simulation section 3304. The input module 3310 provides a model database 3315 with information from the imported file 3305. The input module 3310 also provides the various parameters to an application database 3320. The input module generates an Report Generator report 3325 which can be output to a printer 3380 or another disk file 3385. The input module provides information to the running simulation section 3304 and more particularly to an input file 3330 and a Financial Model 3312. The input file 3330 is provided to an animation simulation model 3335 and to an analysis simulation model 3340. The models 3335, 3340 provide output to a check file 3345 and to an output file 3350. An output module 3355 receives the data from the input module 3310, financial model 3312, and from the output file 3350. The output module 3355 provides data to a model database 3360 and to a Report Generator report 3365. The Report Generator report 3365 can be printed on printer 3380 or output to another disk file 3385.

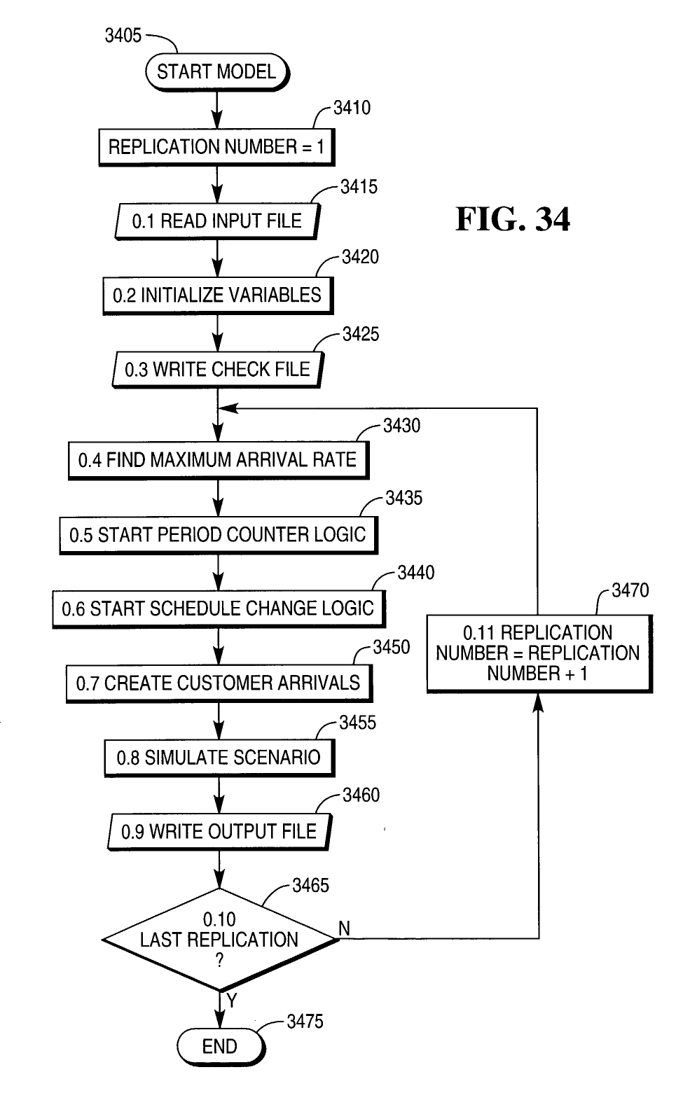

An overview of the simulation process is illustrated in FIG. 34. At 3405, the model is started. At step 3410, the replication number is set at 1. At step 3415, the input file is read. At step 3420, the variables are initialized. At step 3425, the check file is written. At step 3430, the maximum arrival rate is found. At step 3435, the period counter-logic is started. At step 3440, the schedule change logic is started. At step 3450, the create customer arrivals has begun. At step 3455, the scenario is simulated. At step 3460, the output file is written. At step 3465, it is determined if the last replication has been performed. If the answer is no, then at step 3470, the replication number is incremented by 1 and the process is returned to step 3430. If the last replication has been performed, then from step 3465, the process is ended at step 3475.

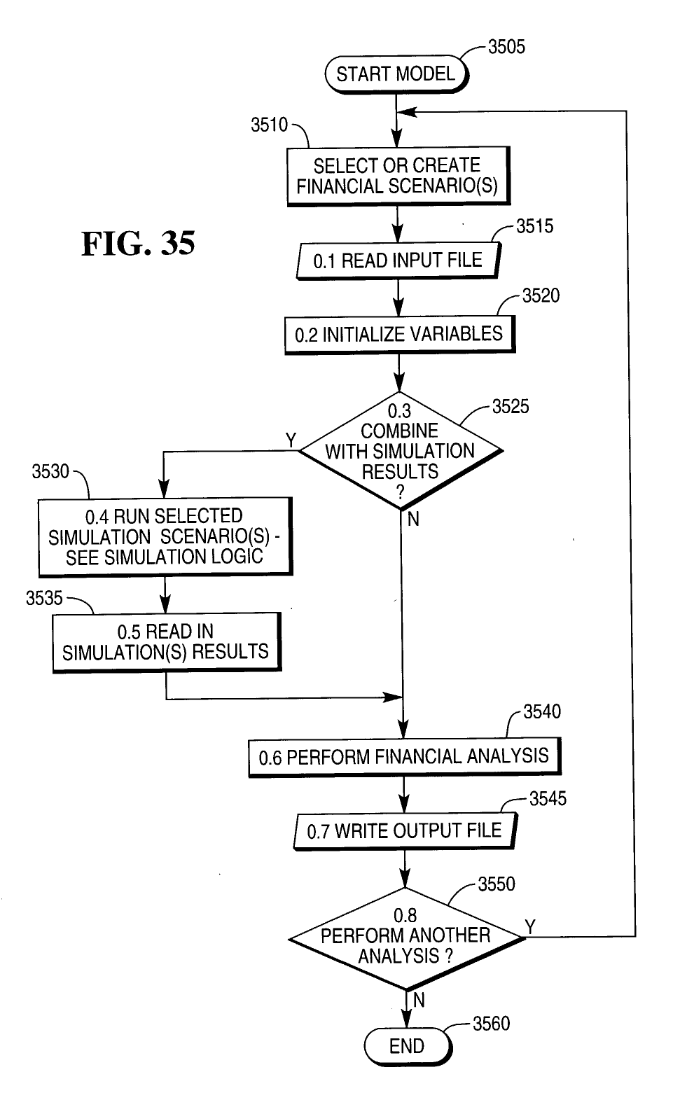

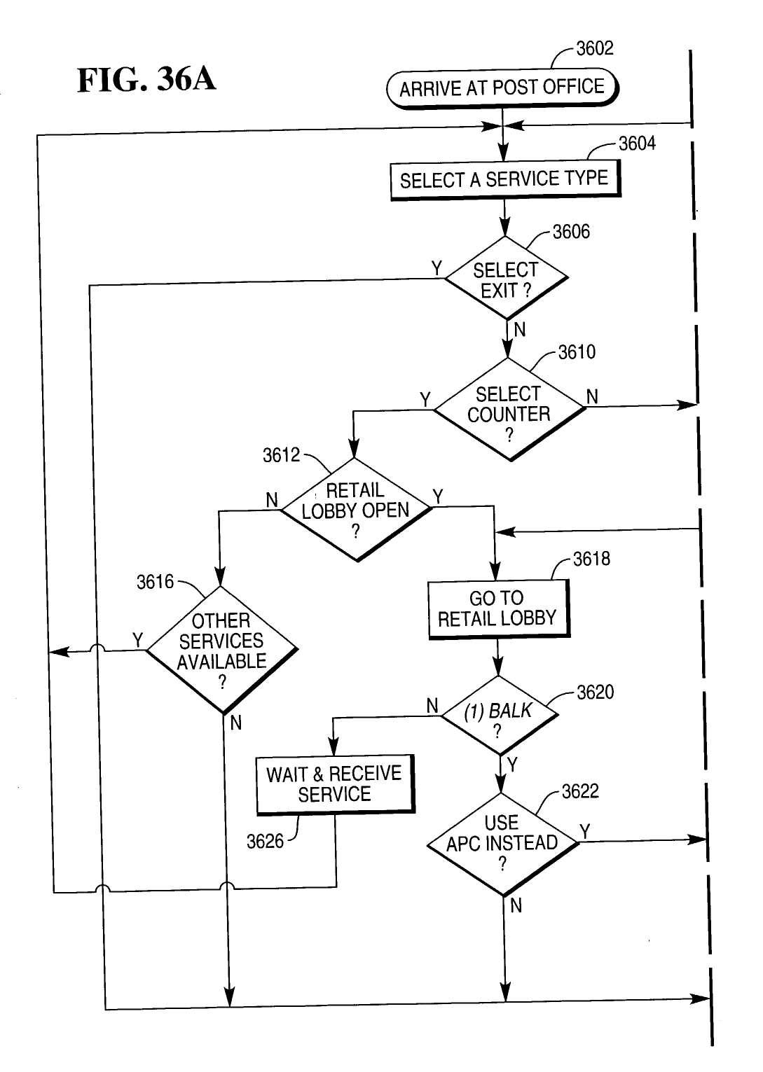

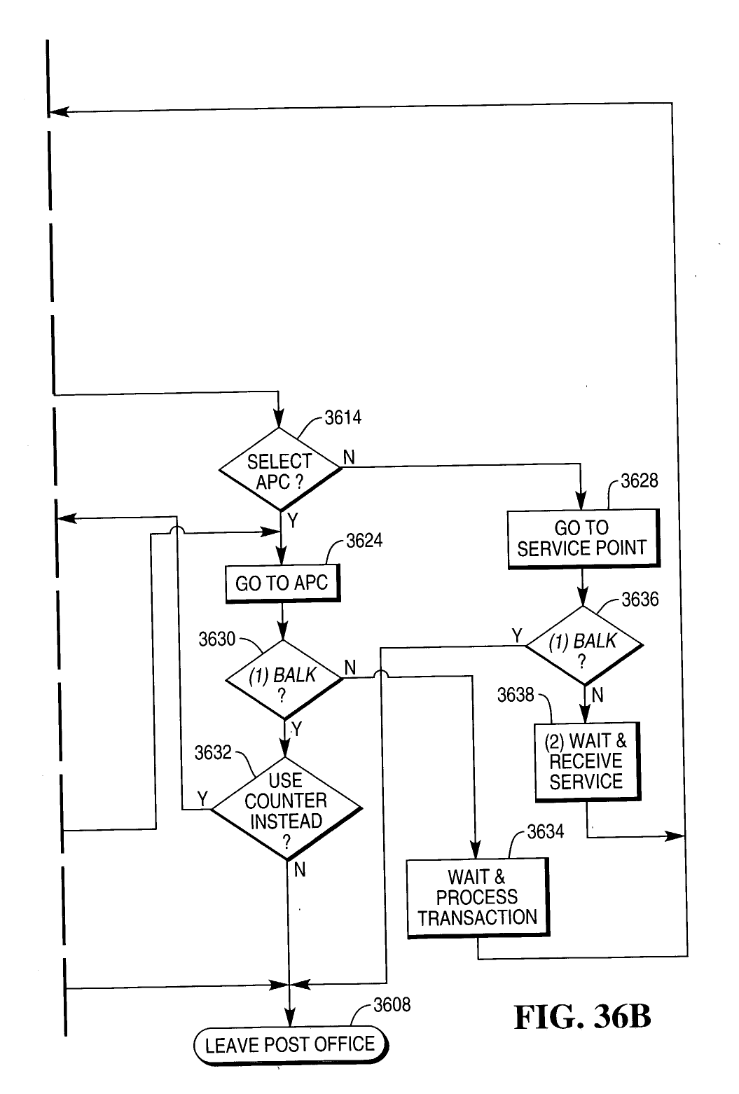

A process flow of the financial analysis module is depicted in FIG. 35. At 3605, the model is started. At step 3510, the user selects or creates a financial scenario using POEM and the flow of control proceeds to step 3515. At step 3515, an input file is read. At step 3520, the variables are initialized. At step 3525, it is determined if the financial analysis is to be combined with the simulation results and if so, the flow proceeds to step 3530. At step 3530, the selected simulation scenario is executed as described in detail with reference to the process flow depicted in FIG. 36. The flow proceeds to step 3535 wherein the simulation results are read. The flow proceeds to step 3540. If the result of the determination of step 3525 is negative, the flow proceeds to step 3540. At step 3540, the financial analysis is performed. At step 3545, an output file is written. At step 3550, a determination is made whether to perform another analysis. If the determination is positive, the flow proceeds to step 3510 where the process is repeated. If the determination is negative, the flow proceeds to step 3560. At step 3560, the model ends.

A process flow of the customer activity module is depicted in FIG. 36. At step 3602, the process is started by a customer arriving at a post office. At step 3604, a a customer selects a service type, i.e., APC, general, copier, multiple stamp vending machine, single stamp vending machine, scale, parcel drop-off box, letter drop-off box, counter, and exit. The flow proceeds to step 3606 wherein it is determined whether a customer selected exit. If the determination is positive, the flow proceeds to step 3608. If the determination is negative, the flow proceeds to step 3610.

At step 3610, it is determined if the customer selected a service available at the retail counter. If the determination is positive, the flow proceeds to step 3612. If the determination is negative, the flow proceeds to step 3614.

Continuing with the process flow at step 3612, a determination is made whether the retail lobby of the post office is open. If the determination is negative, the flow proceeds to step 3616. At step 3616, a determination is made whether other services are available to the customer. If the determination at step 3616 is positive the flow returns to step 3604 and if the determination at step 3616 is negative, the flow proceeds to step 3608 wherein the customer leaves the post office.

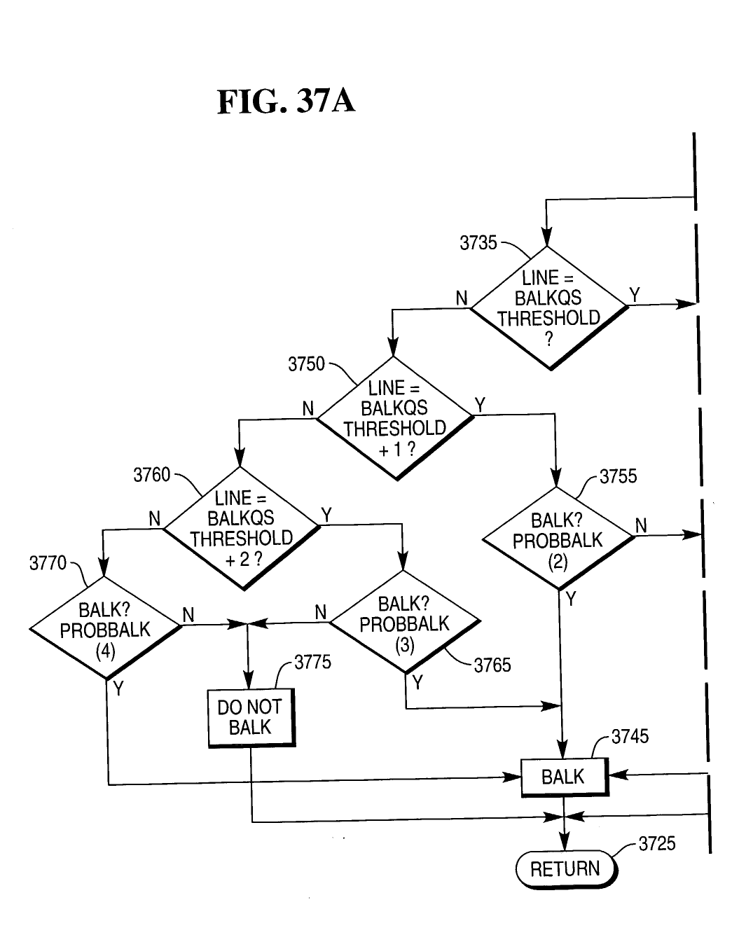

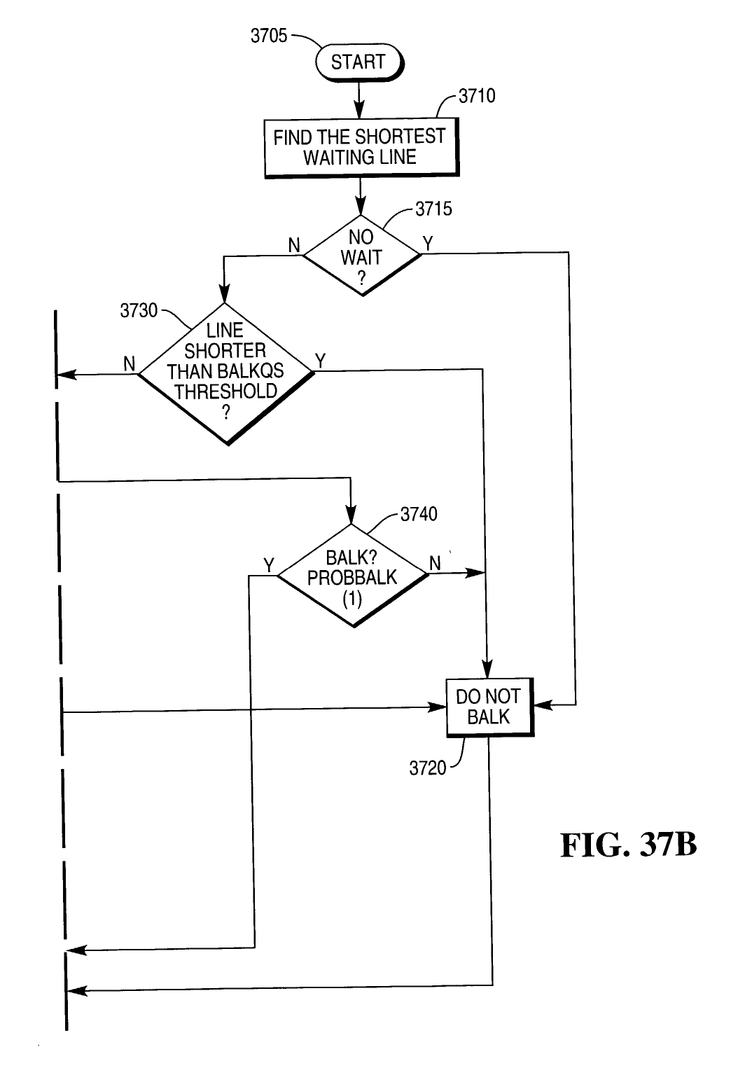

Continuing with step 3612, if the determination is positive, the flow proceeds to step 3618 wherein the customer proceeds to the retail lobby of the post office. The flow then proceeds to a balk determination at step 3620. The customer balk process determination is depicted in FIG. 37 and described in detail below. Continuing with the process flow of FIG. 36 at step 3620, if the determination is positive, the flow proceeds to step 3622 and a determination is made whether the customer uses an APC instead. If the outcome of the determination at step 3622 is negative, the flow proceeds to step 3608 and the customer leaves the post office. If the determination at step 3622 is positive, the flow proceeds to step 3624 wherein the customer proceeds to receive service at an APC.

Continuing with the flow at step 3620, if the outcome of the determination is negative, the flow proceeds to step 3626 where the customer waits and receives service. The flow then proceeds to step 3604.

Continuing with the flow at step 3614, a determination is made whether the user selects an APC and if the determination is positive, the flow proceeds to step 3624 wherein the customer proceeds to receive service at an APC. If the determination at step 3614 is negative, the flow proceeds to step 3628 wherein the customer proceeds to a service point, e.g., a vending machine.

Returning to step 3624, the flow proceeds to step 3630 wherein a balk determination is performed as described in conjunction with step 3620 above and FIG. 37 below. If the outcome of the determination at step 3630 is positive, the flow proceeds to step 3632 wherein a determination is made whether the customer uses the retail counter. If the determination at step 3632 is negative, the flow proceeds to step 3608 and the customer leaves the post office. If the outcome of the determination at step 3632 is positive, the flow proceeds to step 3618 wherein the customer proceeds to the retail lobby.

Returning to step 3630, if the determination is negative, the flow proceeds to step 3634 wherein the customer waits and processes the transaction and the flow proceeds to step 3604.

Returning to step 3628, the flow proceeds to step 3636 wherein a balk determination is performed as described in conjunction with step 3620 above and FIG. 37 below. If the outcome of the determination at step 3636 is positive, the flow proceeds to step 3608 and the customer leaves the post office. If the outcome of the determination at step 3636 is negative, the flow proceeds to step 3638 and the customer waits and receives service and the flow proceeds to step 3604.

The flow of control for the balk determination process is depicted in FIG. 37. At step 3705, the process starts. At step 3710, the shortest waiting line is determined. At step 3715, a determination is made whether there is a wait. If the determination is positive, i.e., there is no wait, the flow proceeds to step 3720 and the customer does not balk. The flow proceeds to step 3725 and returns the determination to the calling process. If the determination is negative, the flow proceeds to step 3730 wherein a determination is made whether the line is shorter than the balk queue size threshold. If the determination is positive the flow proceeds to step 3720. If the determination is negative, the flow proceeds to step 3735 wherein a determination is made whether the line, ie., service queue, is equal to the balk queue size threshold. If the determination is positive, the flow proceeds to step 3740 wherein a determination is made whether a first balk probability is achieved. If the determination at step 3740 is negative, the flow proceeds to step 3720. If the determination at step 3740 is positive, the flow proceeds to step 3745 wherein a balk occurs. The flow proceeds to step 3725.

Returning to step 3735, if the determination is negative, the flow proceeds to step 3750. At step 3750, a determination is made whether the line is equal to the balk queue size threshold plus one. If the determination is positive, the flow proceeds to step 3755 wherein a second balk probability determination is made. If the determination at step 3755 is positive, the flow proceeds to step 3745. If the determination at step 3755 is negative, the flow proceeds to step 3720.

Returning to step 3750, if the determination is negative, the flow proceeds to step 3760. At step 3760, a determination is made whether the line is equal to the balk queue size threshold plus two. If the determination is positive, the flow proceeds to step 3765 wherein a third balk probability determination is made. If the determination at step 3765 is positive, the flow proceeds to step 3745. If the determination at step 3765 is negative, the flow proceeds to step 3775 wherein a balk does not occur.

Returning to step 3760, if the determination is negative, the flow proceeds to step 3770. At step 3770, a fourth balk probability determination is made. If the determination at step 3770 is positive, the flow proceeds to step 3745 wherein a balk occurs. If the determination at step 3770 is negative, the flow proceeds to step 3775 wherein a balk does not occur.

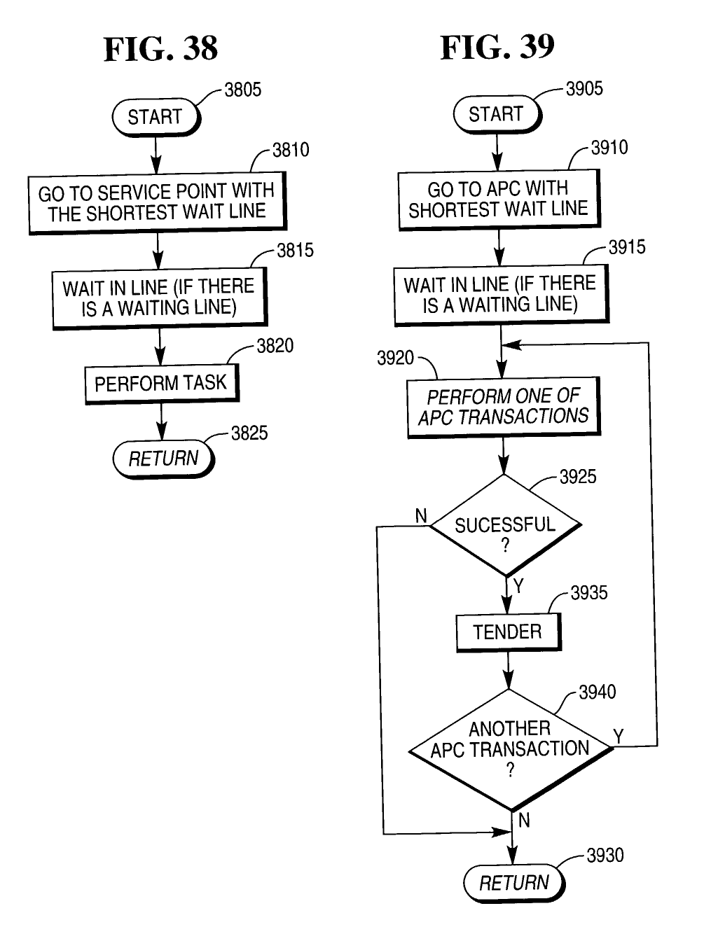

The flow of control for the general service process is depicted in FIG. 38. The general service process may be executed or called from another process. At step 3805, the process starts. At step 3810, a customer proceeds to a service point with the shortest wait line. At step 3815, the customer waits in line if there is a waiting line. At step 3820, the customer performs a task, e.g., copier, multiple stamp vending machine, single stamp vending machine, scale, parcel drop-off box, letter drop-off box, or writing desk. At step 3825, the flow returns to the calling process.

The flow of control for the automated postal center (APC) process is depicted in FIG. 39. The automated postal center process may be executed or called from another process. At step 3905, the process starts. At step 3910, the customer proceeds to the APC having the shortest wait line. At step 3915, the customer waits in line if there is a waiting line. At step 3920, the customer performs on of the APC transactions, e.g., mailing, stamp purchase, information lookup, phonecard. At step 3925, it is determined whether the performed APC task was successful. If the outcome of the determination is negative, the flow proceeds to step 3930 and returns to the calling process. If the outcome is positive, the flow proceeds to step 3935 wherein money is tendered. The flow then proceeds to step 3940 wherein a determination is made whether another APC transaction is to be performed. If the outcome of the determination is positive, the flow proceeds to step 3920 and if the outcome is negative, the flow proceeds to step 3930.

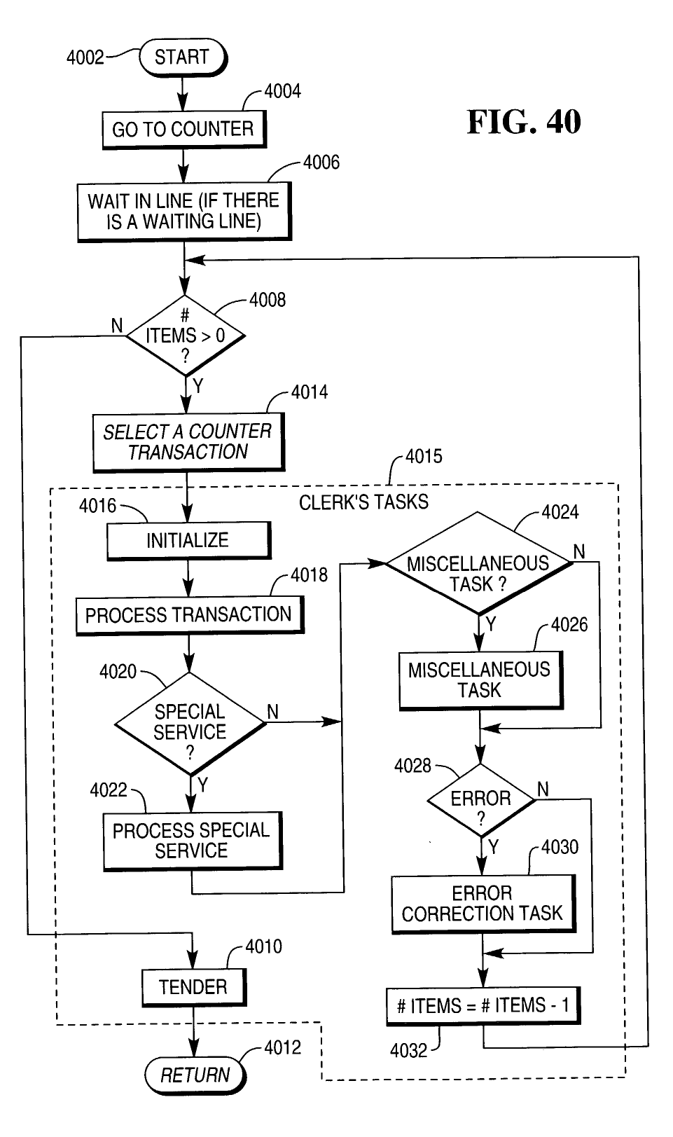

The flow of control for the counter process is depicted in FIG. 40. The counter process may be executed or called from another process. At step 4002, the process starts. At step 4004, the customer proceeds to the counter. At step 4006, the customer waits in line if there is a waiting line. The flow proceeds to step 4008 wherein a determination is made whether a customer has any items for a transaction remaining. If the outcome of the determination at step 4008 is negative, the flow proceeds to step 4010 wherein the customer checks out by tendering currency to a clerk and the flow proceeds to step 4012 and returns to the calling process.

If the outcome of the determination at step 4008 is positive, the flow proceeds to step 4014 wherein the customer selects a counter transaction to perform. The flow of control then proceeds to the clerk task portion of the counter process as indicated by dotted line area of 4015. At step 4016, an initialization step is performed and the flow proceeds to step 4018 wherein the transaction is processed by the clerk.

The flow then proceeds to step 4020 wherein a determination is made whether a special service is requested by the customer. If the outcome of the determination at step 4020 is positive, the flow proceeds to step 4022 wherein the special service is processed. The flow then proceeds to step 4024.

If the outcome of the determination at step 4020 is negative, the flow proceeds to step 4024.

At step 4024, a determination is made whether a miscellaneous task is requested. If the outcome of the determination is positive, the miscellaneous task is performed at step 4026 and the flow proceeds to step 4028. If the outcome is negative, the flow proceeds to step 4028. At step 4028, a determination is made whether an error occurred. If the outcome of the determination at step 4028 is positive, an error correction task is performed at step 4030 and the flow proceeds to step 4032. If the outcome is negative, the flow proceeds to step 4032. At step 4032, the number of items is reduced by one and the flow returns to step 4008.

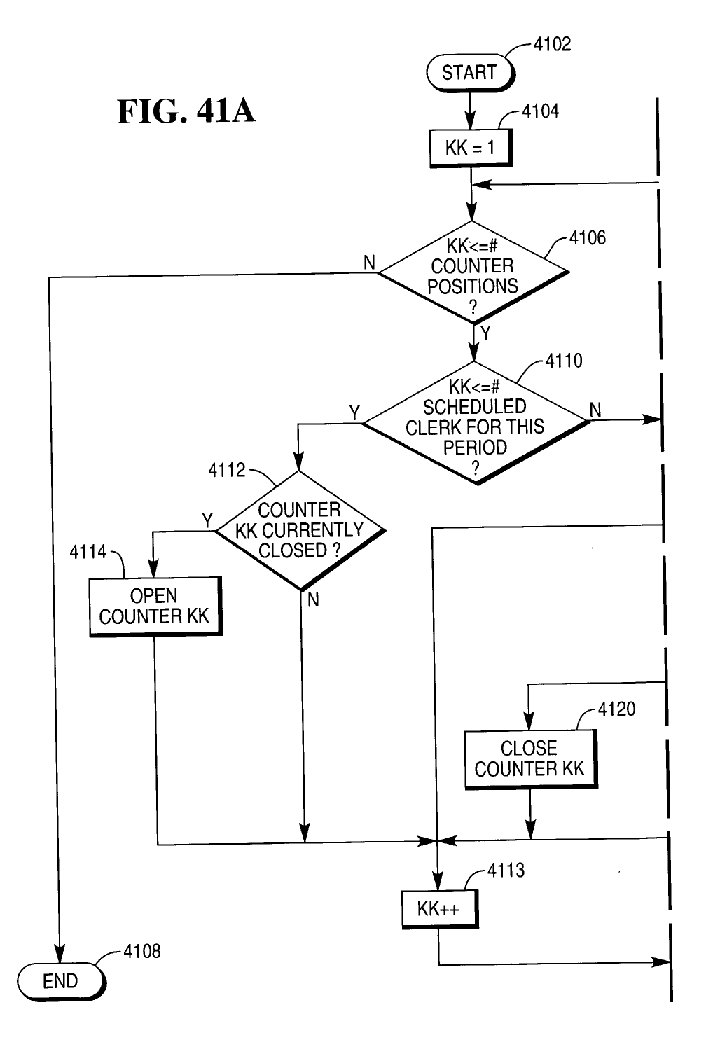

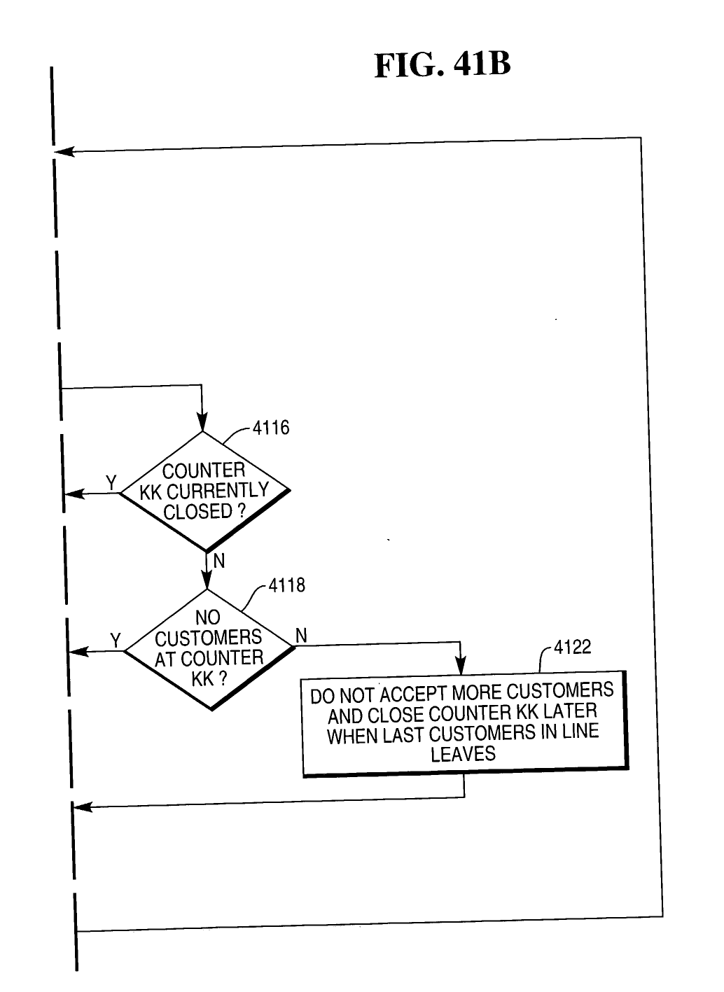

The flow of control for a clerk schedule process is depicted in FIG. 41. The process starts at step 4102. At step 4104, KK is set to one. At step 4106, a determination is made whether KK is less than or equal to the number of counter positions. If the outcome of the step 4106 determination is negative, the flow proceeds to step 4108 wherein the flow returns to the calling process. If the outcome of the step 4106 determination is positive, the flow proceeds to step 4110.

At step 4110, a determination is made whether KK is less than or equal to the number of scheduled clerks for the time period. If the outcome of the determination is positive, the flow proceeds to step 4112. At step 4112, a determination is made whether counter KK is currently closed. If the outcome is negative, the flow proceeds to step 4113 wherein KK is incremented and the flow proceeds to step 4106. If the outcome is positive, the flow proceeds to step 4114 wherein counter KK is opened and the flow proceeds to step 4113.

Returning to step 4110, if the outcome of the determination is negative, the flow proceeds to step 4116. At step 4116, a determination is made whether counter KK is currently closed. If the outcome of the determination is positive, the flow proceeds to step 4113. If the outcome of the determination is negative, the flow proceeds to step 4118.

At step 4118, a determination is made whether there are no customers at counter KK. If the outcome of the determination is positive, i.e., there are no customers at the counter, the flow proceeds to step 4120. At step 4120, counter KK is closed and the flow proceeds to step 4113. If the outcome of the determination at step 4118 is negative, the flow proceeds to step 4122. At step 4122, more customers are not accepted and counter KK is later closed when the last customer in line is served. The flow then proceeds to step 4113. The clerk schedule process is typically executed on half hour intervals of simulation time although different intervals may be used.

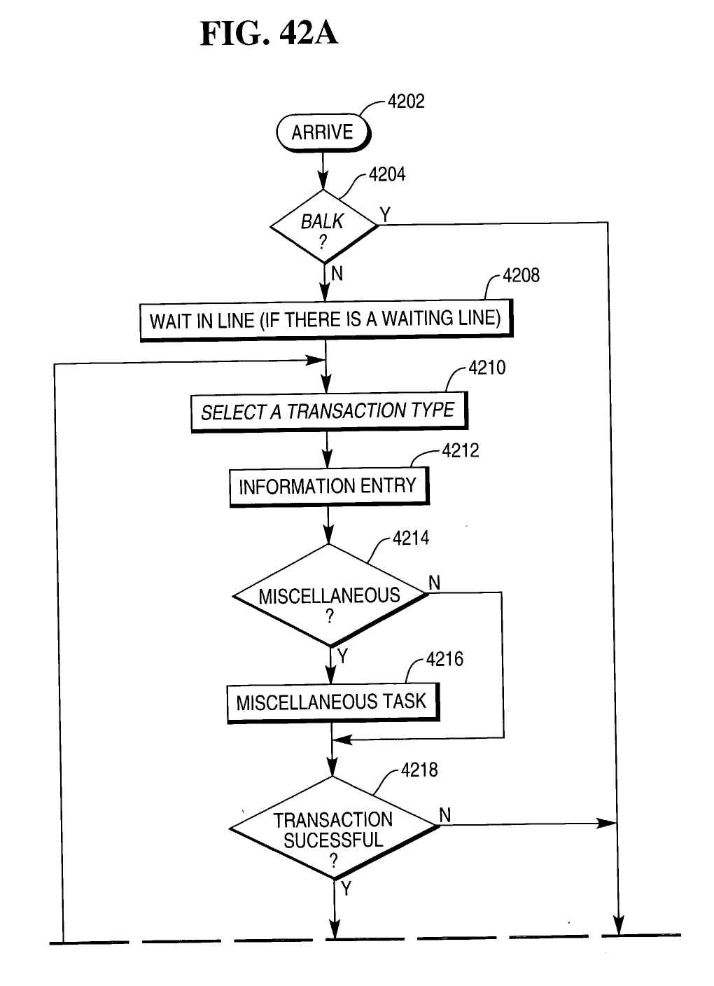

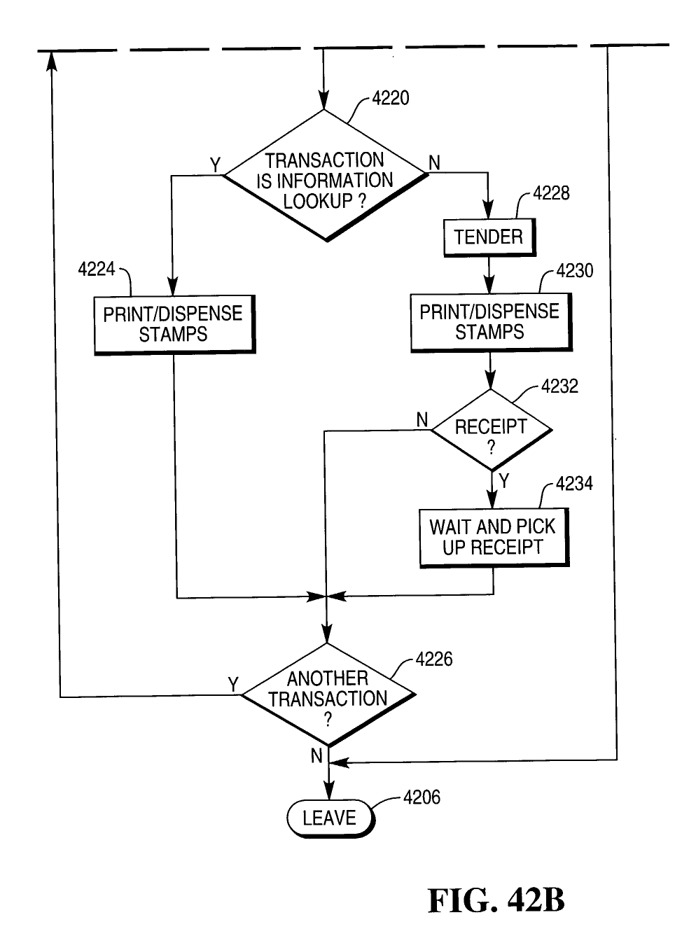

The flow of control of a customer transaction process at an APC is depicted in FIG. 42. At step 4202, the process starts. At step 4204, a balk determination is performed as described above. If the outcome of the step 4204 determination is positive, the flow proceeds to step 4206 wherein the customer leaves. If the outcome of the step 4204 determination is negative, the flow proceeds to step 4208.

At step 4208, the customer waits in line if there is a waiting line. At step 4210, a transaction type is selected, e.g., mailing, stamp purchase, information lookup, phonecard, and general. At step 4212, information entry occurs and the flow proceeds to step 4214. At step 4214, a determination is made whether a miscellaneous task is requested. If the outcome of the step 4214 determination is positive, the flow proceeds to step 4216 wherein the miscellaneous task is performed and the flow proceeds to step 4218. If the outcome of the step 4214 determination is negative, the flow proceeds to step 4218.

At step 4218, a determination is made whether the transaction was successful. If the outcome is negative, the flow proceeds to step 4204. If the outcome of the step 4218 determination is positive, the flow proceeds to step 4220.

At step 4220, a determination is made whether the transaction is an information lookup transaction. If the outcome of the step 4220 determination is positive, the flow proceeds to step 4222 and stamps are printed or dispensed and the flow proceeds to step 4226 wherein a determination is made whether the customer requires another transaction. If the outcome of the step 4226 determination is negative the flow proceeds to step 4206 and the customer leaves the counter at the post office. If the outcome of the step 4226 determination is positive, the flow returns to step 4210.

Returning to step 4220, if the outcome of the determination is negative, the flow proceeds to step 4228 wherein the customer tenders currency to the clerk. The flow proceeds to step 4230 wherein stamps are printed or dispensed and the flow proceeds to step 4232 wherein a determination is made whether the customer desires a receipt. If the outcome of the step 4232 determination is negative, the flow proceeds to step 4226 described above. If the outcome of the step 4232 determination is positive, the flow proceeds to step 4234 wherein the customer waits and receives a receipt. The flow then proceeds to step 4226.

Advantageously, the Post office Effectiveness Model (POEM) is a self-contained PC desktop application enabling an analyst to quantitatively predict the operational and financial impact of changes to Post Office and Automated Postal Center (APC) operations. This software application contains a Simulation Analysis Module and a Financial Analysis Module. The Simulation Module consists of two simulation models: APC model and PO model. The APC model represents the detailed transaction process performed by customers at an Automated Postal Center. This model allows the user or analyst to predict the effect of changes in APC design, transaction features, and transaction times on customer service (e.g., queue times, queue size, and throughput). The PO model represents the complex interactions between customers, staff, and the primary service points of a Post Office. An analyst can use the PO model to predict the effect of an unlimited number of changes in post office design, customer demand patterns, and checkout procedures on post office performance. The Financial Analysis Module allows the user to create a Profit and Loss (P&L) statement showing the cash flows, Net Present Value (NPV), IRR for deploying APCs using simulation results or user input values. An analyst can use the POEM to provide a sound and quantified basis for developing a business case for investing in new technologies, i.e., APC, or other design and procedure changes in a post office environment.

It will be readily seen by one of ordinary skill in the art that the present invention fulfills all of the objects set forth above. After reading the foregoing specification, one of ordinary skill will be able to affect various changes, substitutions of equivalents and various other aspects of the invention as broadly disclosed herein. It is therefore intended that the protection granted hereon be limited only by the definition contained in the appended claims and equivalents thereof.

What is claimed is:

1. A method of quantitatively evaluating alternative post office operations using a simulation model, comprising:
inputting parameter values describing post office operations into the simulation model;
running the simulation model; and
outputting results from the simulation model.

2. The method of claim 1, wherein the input parameters are listed in a data input dictionary used to define the parameters used in the simulation model.

3. The method of claim 1, wherein the simulation model includes one of a automated postal center model and a post office model.

4. The method of claim 3, wherein the automated postal center model includes the ability to model changes in automated postal center design, transaction features, and transaction times.

5. The method of claim 3, wherein the post office model includes the ability to model interactions between customers, staff, and service points of a post office.

6. The method of claim 1, wherein the simulation model simulates a number and type of service points, transaction times, customer arrival patterns, number of items purchased, and personnel schedules.

7. The method of claim 3, wherein the post office model includes simulation parameter categories of model parameters, customer demand, transaction characteristics, labor schedule, and configuration.

8. The method of claim 3, wherein the automated postal center model includes simulation parameter categories of model parameters, customer demand, transaction probabilities, stamp purchase transactions, mailing transactions, information lookup transactions, money order transactions, phone card transactions, and general transactions.

9. The method of claim 1, wherein the parameters are divided into a customer demand category, a transaction characteristics category, a labor schedule category, a configuration category, and a financial parameters category.

10. The method of claim 9, wherein the configuration category includes parameters defining the length and resources in a scenario.

11. The method of claim 10, wherein the resources include a number of retail counters and number of automated postal centers.

12. The method of claim 9, wherein the customer demand category has parameters controlling the workload of the post office.

13. The method of claim 12, wherein the parameters that control the workload include a number of customer arrivals, where customers go, and number of items purchased.

14. The method of claim 9, wherein the parameters include a number of replications, a stream number identifier and check input option identifier.

15. The method of claim 1, further comprising editing the input parameter values.

16. The method of claim 1, wherein the input parameter values include a value and a range.

17. The method of claim 1, further comprising one of outputting a report and displaying an animation of the results of the simulation.

18. The method of claim 1, further comprising repeating said running step and step outputting step.

19. The method of claim 1, wherein the results of said outputting step include performance measurements for each type of resource.

20. The method of claim 3, wherein the post office model includes non-scalar parameters.

21. The method of claim 20, wherein the non-scalar parameters include an expected number of arrivals, a balking probability, a customer decision matrix, a clerk schedule, a supervisor schedule, and a number of transactions distribution.

22. A method of quantitatively evaluating alternative post office operations using a simulation model and a financial analysis model, comprising:
inputting parameter values describing post office operations into the simulation model and the financial analysis model;
running the simulation model;
running the financial analysis model;
outputting results from the financial analysis model; and
outputting results from the simulation model.

23. The method of claim 22, wherein the financial analysis model enables the user to create a profit and loss statement for the post office.

24. The method of claim 23, wherein the profit and loss statement includes a cash flow, a net present value, and an internal rate of return.
